(19) United States
(12) Patent Application Publication
(10) Pub. No.: US 2013/0114710 A1
(43) Pub. Date: May 9, 2013

(54) METHOD AND APPARATUS FOR ENCODING VIDEO BY PREDICTION USING REFERENCE PICTURE LIST, AND METHOD AND APPARATUS FOR DECODING VIDEO BY PERFORMING COMPENSATION USING REFERENCE PICTURE LIST

(71) Applicant: SAMSUNG ELECTRONICS CO., LTD., Suwon-si (KR)

(72) Inventors: Young-o PARK, Seoul (KR); Seung-soo JEONG, Seoul (KR); Chan-yul KIM, Seongnam-si (KR); Jeong-hoon PARK, Seoul (KR); Tammy LEE, Seoul (KR); Jae-hyun KIM, Seoul (KR)

(73) Assignee: SAMSUNG ELECTRONICS CO., LTD., Suwon-si (KR)

(21) Appl. No.: 13/672,311

(22) Filed: Nov. 8, 2012

Related U.S. Application Data
(60) Provisional application No. 61/587,327, filed on Jan. 17, 2012.
(60) Provisional application No. 61/564,066, filed on Nov. 28, 2011.
(60) Provisional application No. 61/557,053, filed on Nov. 8, 2011.

(30) Foreign Application Priority Data
Apr. 10, 2012 (KR) 10-2012-0037555

(51) Int. Cl. H04N 7/26; H04N 7/32

(52) U.S. Cl. CPC H04N 19/00569
USPC 375/240.12

(57) ABSTRACT

A video prediction encoding method including setting a default number of reference images assigned to a list combination (LC) reference list in units of pictures, the LC reference list including at least one reference image from among a plurality of reference images included in reference lists L0 and L1 which are information about lists of reference images for prediction encoding a current image that is a B type slice; and prediction encoding the current image by using the determined LC reference list including at least one reference image from among the plurality of reference images included in the reference lists L0 and L1, based on the default number.

### CROSS-REFERENCE TO RELATED PATENT APPLICATION

This application claims the benefit of U.S. Provisional Application No. 61/557,053, filed on Nov. 8, 2011, U.S. Provisional Application No. 61/564,066, filed on Nov. 28, 2011, and U.S. Provisional Application No. 61/587,327, filed on Jan. 17, 2012, in the US Patent and Trademark Office (PTO), and claims priority from Korean Patent Application No. 10-2012-0037555, filed on Apr. 10, 2012 in the Korean Intellectual Property Office, the disclosures of which are incorporated herein in their entireties by reference.

### BACKGROUND

1. Field

One or more aspects of exemplary embodiments relate to predicting video, encoding video, and decoding video by performing video prediction.

2. Related Art

As hardware for reproducing and storing high resolution or high quality video content is being developed and supplied, a need for a video codec for effectively encoding or decoding high resolution or high quality video content is increasing. In a related art video codec, video is encoded according to a limited encoding method, based on a macroblock having a predetermined size.

A video codec may reduce the amount of data that is encoded and output by using a prediction technique, based on whether the images of a video are temporally or spatially related to one another. According to the prediction technique, image information is recorded using the temporal or spatial distance between images of a video, a prediction error, etc. to predict a current image from neighboring images.

### SUMMARY

According to an aspect of an exemplary embodiment, there is provided a method of prediction encoding video, the method including: setting list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; determining the LC reference list to include at least one reference image from among the plurality of reference images included in the reference lists L0 and L1, based on the LC default number information; and prediction encoding the current image that is a B type slice by using the determined LC reference list.

The setting of the LC default number information in units of pictures may include setting LC active number modification flag information and LC active number information in units of slices, based on reference list active number modification flag information indicating whether a number of active reference images assigned to a reference list is arbitrarily changed, wherein the LC active number modification flag information indicates whether a number of active reference images assigned to the LC reference list is arbitrarily changed, and the LC active number information indicates a current number of active reference images assigned to the LC reference list after the number of active reference images assigned to the LC reference list is arbitrarily changed.

The setting of the LC default number information in units of pictures may include setting LC modification-related information including reference images assigned to the LC reference list or information about a method of changing a reference order, in units of slices.

Transmission of LC flag information indicating whether the LC reference list is to be constructed using at least one reference image from among the plurality of reference images included in the reference list L0 and the reference list L1 may be not determined and encoded.

The method may further include transmitting the LC default number information together with parameters for a current picture.

The method may further include transmitting the LC active number information together with parameters for a current slice.

The method may further include transmitting the LC modification related information together with parameters for a current slice.

According to another aspect of an exemplary embodiment, there is provided a method of prediction decoding video, the method including: decoding list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; determining the LC reference list to include at least one reference image from among the plurality of reference images included in the reference lists L0 and L1, based on the LC default number information; and prediction decoding the current image that is a B type slice by using the determined LC reference list.

The decoding of the LC default number information in units of pictures may include: decoding LC active number modification flag information in units of slices, based on reference list active number modification flag information indicating whether a number of active reference images assigned to a reference list is arbitrarily changed, the LC active number modification flag information indicating whether a number of active reference images assigned to the LC reference list is arbitrarily changed; and decoding LC active number information indicating a current active number of reference images assigned to the LC reference list after the number of active reference images assigned to the LC reference list is arbitrarily changed, based on the decoded LC active number modification flag information.

The decoding of the LC default number information in units of pictures may include decoding LC modification-related reference information including reference images assigned to the LC reference list or information about a method of changing a reference order, in units of slices.

The determining of the LC reference list may include determining the LC reference list without having to decode LC flag information indicating whether the LC reference list is to be constructed using at least one reference image from among the plurality of reference images included in the reference list L0 and the reference list L1.

The decoding of the LC default number information in units of pictures may include: extracting the LC default number information together with parameters for a current picture, from a received video stream; and decoding the extracted LC default number information.

The decoding of the LC active number information in units of slices may include: extracting the LC active number information together with parameters for a current slice, from a received video stream; and decoding the extracted LC active number information.

According to another aspect of an exemplary embodiment, there is provided an apparatus for prediction encoding video, the apparatus including: a list combination (LC) related information determination unit for setting LC default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; and a prediction encoder for determining the LC reference list to include at least one reference image from among the plurality of reference images included in the reference lists L0 and L1, based on the LC default number information, and prediction encoding the current image that is a B type slice by using the determined LC reference list.

According to another aspect of an exemplary embodiment, there is provided an apparatus for prediction decoding video, the apparatus including: an LC-related information decoder for decoding list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; and a prediction decoder for determining the LC reference list to include at least one reference image from among the plurality of reference images included in the reference lists L0 and L1, based on the LC default number information, and prediction decoding the current image that is a B type slice by using the determined LC reference list.

According to another aspect of an exemplary embodiment, there is provided a non-transitory computer readable recording medium having recorded thereon a program for executing the method of encoding a video.

According to another aspect of an exemplary embodiment, there is provided a non-transitory computer readable recording medium having recorded thereon a computer program for executing the video prediction encoding method.

According to another aspect of an exemplary embodiment, there is provided a non-transitory computer readable recording medium having recorded thereon a computer program for executing the video prediction decoding method.

### BRIEF DESCRIPTION OF THE DRAWINGS

The above and other features and advantages will become more apparent by describing in detail exemplary embodiments with reference to the attached drawings in which:

FIG. 1A is a block diagram of a video prediction encoding apparatus according to an aspect of an exemplary embodiment;

FIG. 1B is a block diagram of a video encoder according to an aspect of an exemplary embodiment;

FIG. 2 is a block diagram of a video prediction decoding apparatus according to an aspect of an exemplary embodiment;

FIG. 3 illustrates an order of displaying a picture sequence of video and an order of coding the picture sequence, according to an aspect of an exemplary embodiment;

FIG. 4 is a table showing a relation among reference lists L0 and L1 and a list combination (LC) reference list of each of pictures that are B type slices included in the picture sequence of FIG. 3, according to an aspect of an exemplary embodiment;

FIG. 5 illustrates syntax of LC related information set in units of slices, according to an aspect of an exemplary embodiment;

FIG. 6 illustrates syntax of reference list default number information according to an aspect of an exemplary embodiment;

FIG. 7 illustrates LC reference lists set according to LC default number information according to an aspect of an exemplary embodiment;

FIGS. 8 and 9 illustrate syntaxes of reference list active number related information according to various aspects of exemplary embodiments;

FIG. 10 illustrates syntax of reference list modification information according to an aspect of an exemplary embodiment;

FIG. 11 is a flowchart illustrating a video prediction encoding method according to an aspect of an exemplary embodiment;

FIG. 12 is a flowchart illustrating a video prediction decoding method according to an aspect of an exemplary embodiment;

FIG. 13 is a block diagram of a video encoding apparatus capable of predicting video, based on coding units having a tree structure, according to an aspect of an exemplary embodiment;

FIG. 14 is a block diagram of a video decoding apparatus capable of predicting video based on coding units having a tree structure, according to an aspect of an exemplary embodiment;

FIG. 15 is a diagram illustrating a concept of coding units according to an aspect of an exemplary embodiment;

FIG. 16 is a block diagram of an image encoder based on coding units, according to an aspect of an exemplary embodiment;

FIG. 17 is a block diagram of an image decoder based on coding units, according to an aspect of an exemplary embodiment;

FIG. 18 is a diagram illustrating deeper coding units according to depths, and partitions according to an aspect of an exemplary embodiment;

FIG. 19 is a diagram illustrating a relationship between a coding unit and transformation units, according to an aspect of an exemplary embodiment;

FIG. 20 is a diagram illustrating encoding information of coding units corresponding to a coded depth, according to an aspect of an exemplary embodiment;

FIG. 21 is a diagram of deeper coding units according to depths, according to an aspect of an exemplary embodiment;

FIGS. 22, 23, and 24 are diagrams illustrating a relationship between coding units, prediction units, and transformation units, according to an aspect of an exemplary embodiment;

FIG. 25 is a diagram illustrating a relationship between a coding unit, a prediction unit, and a transformation unit, according to encoding mode information of Table 1;

FIG. 26 is a flowchart illustrating a method of encoding video, based on coding units having a tree structure, according to an aspect of an exemplary embodiment; and

FIG. 27 is a flowchart illustrating a method of decoding video, based on coding units having a tree structure, according to an aspect of an exemplary embodiment.

### DETAILED DESCRIPTION

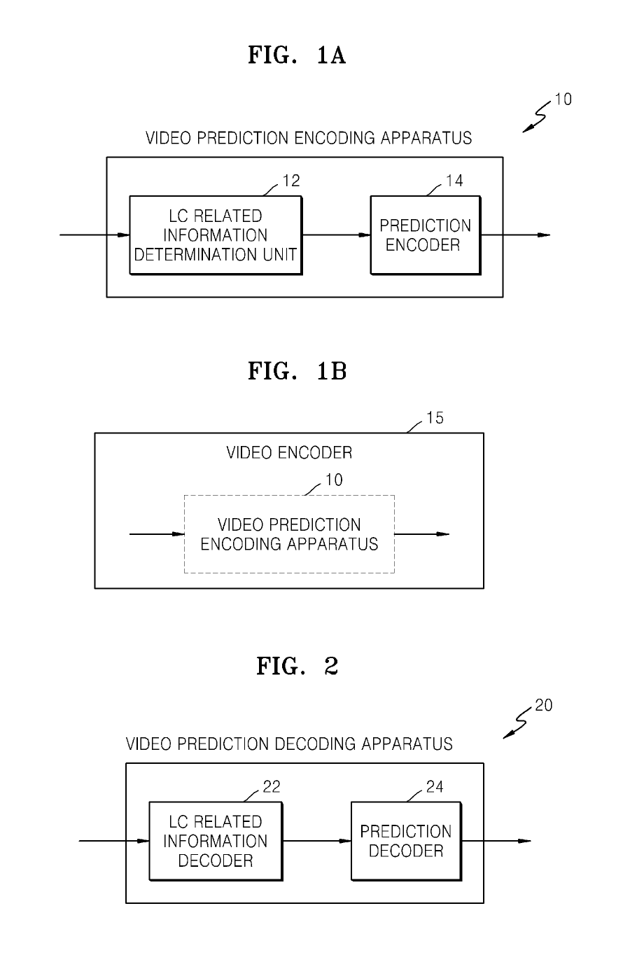

Hereinafter, a video prediction method and apparatus capable of performing bi-prediction based on reference lists, a video prediction encoding method and apparatus, and a video prediction decoding method and apparatus according to aspects of exemplary embodiments will be described with reference to FIGS. 1A to 12.

FIG. 1A is a block diagram of a video prediction encoding apparatus 10 according to an aspect of an exemplary embodiment. FIG. 1B is a block diagram of a video encoder 15 according to an aspect of an exemplary embodiment.

The video prediction encoding apparatus 10 includes a list combination (hereinafter referred to as “LC”) related information determination unit 12 and a prediction encoder 14.

The video prediction encoding apparatus 10 may further include a controller (not shown) for controlling overall operations of the LC-related information determination unit 12 and the prediction encoder 14. Otherwise, the LC-related information determination unit 12 and the prediction encoder 14 may be respectively operated by one or more processors corresponding thereto (not shown) and the processors may operate interactively with each other, thereby operating the video prediction encoding apparatus 10. Otherwise, the LC-related information determination unit 12 and the prediction encoder 14 may be operated under control of an external processor (not shown) of the video prediction encoding apparatus 10 according to an aspect of an exemplary embodiment.

According to an aspect of an exemplary embodiment, the video prediction encoding apparatus 10 may further include at least one data storage unit (not shown) (e.g., memory) that stores data input to or output from the LC-related information determination unit 12 and the prediction encoder 14. The video prediction encoding apparatus 10 may further include a memory controller (not shown) that controls data to be input to or output from the data storage unit.

According to an aspect of an exemplary embodiment, the video prediction encoding apparatus 10 may perform prediction on images of video. The video prediction encoding apparatus 10 may determine prediction information indicating the temporal or spatial distance between a current image and a neighboring image, a prediction error (a residual component) and so on. Thus, information about an image may be recorded using the prediction information, instead of the entire data of the image.

Prediction encoding is classified into inter prediction for predicting a current image by using a previous image and a subsequent image in a temporal order, and intra prediction for predicting the current image by using neighboring images in a spatial domain. Thus, in inter prediction, the current image is predicted by using a previous image and a subsequent image adjacent to the current image in the temporal order as reference images. In intra prediction, the current image is predicted by using neighboring images adjacent to the current image in the spatial domain as reference images. The current image and the reference images may be image data units, e.g., pictures, frames, fields, or slices.

According to an aspect of an exemplary embodiment, for fast calculation when performing prediction encoding, the video prediction encoding apparatus 10 may divide a current image into a plurality of blocks and perform prediction encoding on the blocks. In other words, one of the plurality of blocks divided from the current image may be used as a reference image to perform prediction encoding on the current block.

The reference lists may include reference lists L0 and L1, and an LC reference list. For example, reference lists for performing forward prediction on a P type slice may include the reference list L0 for list 0 prediction. Reference lists for a B type slice on which bi-prediction, including forward prediction, backward prediction, and bidirectional prediction, may include not only the reference list L0 but also the reference list L1 for list 1 prediction.

Reference lists for performing bi-prediction on a B type slice may further include the LC reference list. The LC reference list may include at least one from among reference images included in the reference list L0 and reference images included in the reference list L1.

Each of the reference lists L0 and L1, and the LC reference list may include an index indicating at least one reference image, and reference order information. A default number of active reference images assigned to a reference list may be predetermined. However, the number of reference images or a reference order in which reference images are to be referred to may be altered for each image. Thus, the video prediction encoding apparatus 10 may set information about a default number of active reference images assigned to a reference list, information about a change in the number of reference images, information about a change in reference images, information about a change in a reference order, and so on.

According to an aspect of an exemplary embodiment, the prediction encoder 14 may determine reference images to be used to prediction encoding a current image. The prediction encoder 14 may determine an image to be currently referred to from among images assigned to a reference list for a current image that is a B type slice. Also, the prediction encoder 14 may determine reference information indicating at least one reference image to predict a current image.

The prediction encoder 14 may determine a reference image from among a previous image displayed ahead of a current image that is a B type slice and a subsequent image displayed after the current image so as to perform bi-prediction on the current image. Also, the prediction encoder 14 may determine a reference image from among images that are processed to be reproduced before the current image is coded. Thus, the prediction encoder 14 may detect a block having a least error with respect to the current image by checking a similarity between each of coded previous images and subsequent blocks and the current image. The detected block may be determined as a reference block of a reference image. Information indicating a reference image, e.g., the number or index of an image, may be determined as the reference information. Motion information pointing a reference block included in a reference image may also be determined as the reference information.

For intra prediction, an index representing a reference region from among neighboring regions adjacent to a current region in the current image may be determined as reference information.

The prediction encoder 14 may determine a prediction error that is an error between a current image and a reference image.

According to an aspect of an exemplary embodiment, the prediction encoder 14 may determine a reference list including reference images and representing a reference order in which the reference images are to be referred. The prediction encoder 14 may determine a first reference list including reference information for first-direction prediction and a second reference list including reference information for second-direction prediction from among reference images for bi-prediction. For example, the reference list L0 may primarily include an index for a reference image for forward prediction, and the reference list L1 may primarily include an index for a reference image for backward prediction. However, the reference lists L0 and L1 are not limited thereto.

The LC reference list may include both an index for a reference image for forward prediction and an index for a reference image for backward prediction.

According to an aspect of an exemplary embodiment, the prediction encoder 14 may determine a reference order in which reference images assigned to each of the reference lists are to be referred. For example, the reference order may be determined in such a manner that a reference image that is displayed adjacent to a displayed current image in a temporal sense from among reference images assigned to a reference list may be first referred to.

According to an aspect of an exemplary embodiment, the prediction encoder 14 may determine prediction information by performing prediction encoding based on reference images included in a reference list. The prediction encoder 14 may determine prediction information by performing prediction encoding on a current image by referring to indexes of the reference images included in the reference list and the reference order.

For example, the prediction encoder 14 may perform prediction encoding on a current image that is a P type slice by using the reference list L0, or may perform prediction encoding on a current image that is a B type slice by using at least one from among the reference lists L0 and L1, and the LC reference list.

According to an aspect of an exemplary embodiment, the prediction encoder 14 may determine a number of reference images and a reference order, based on information related to a reference list set by the LC-related information determination unit 12.

According to an aspect of an exemplary embodiment, the LC-related information determination unit 12 may set information related to a reference list, e.g., information about a default number of active reference images assigned to the reference list, a change in the number of reference images, a change in reference images, a change in a reference order, and so on.

The number of active reference images assigned to the reference list means a number of images that are available to be reference images, i.e. a maximum reference index of reference pictures. A default number of reference lists may mean default number of active reference images assigned to the reference list. The LC-related information determination unit 12 may set LC default number information representing a default number of active reference images assigned to an LC reference list, in units of pictures.

According to an aspect of an exemplary embodiment, the prediction encoder 14 may determine a reference list indicating a reference picture of a current image that is a B type slice.

According to an aspect of an exemplary embodiment, the prediction encoder 14 may determine an LC reference list in such a manner that the LC reference list may include at least one reference image from among reference images included in the reference lists L0 and L1, within a range of a default number of active reference images assigned to an LC reference list, based on the LC default number information.

According to an aspect of an exemplary embodiment, the LC-related information determination unit 12 may set at least one from among L0 default number information about reference lists L0 and L1 default number information about the reference list L1, and LC default number information, in units of pictures.

According to an aspect of an exemplary embodiment, an active number of reference images included in a reference list means a current number of active reference images when a number of active reference images for a current image is arbitrarily changed.

According to an aspect of an exemplary embodiment, the LC-related information determination unit 12 may set LC active number modification flag information indicating whether a number of active reference images assigned to an LC reference list is arbitrarily changed, LC active number information indicating a number of active reference images after the LC reference list is arbitrarily changed, in units of slices.

According to an aspect of an exemplary embodiment, the LC-related information determination unit 12 may set LC active number modification flag information and LC active number information, based on reference list active number modification flag information indicating whether a number of active reference images is arbitrarily changed.

According to an aspect of an exemplary embodiment, the LC-related information determination unit 12 may set at least one from among L0 active number information about the reference lists L0 and L1 active number information about the reference list L1, and LC active number information, based on reference list active number modification flag information, in units of slices.

According to an aspect of an exemplary embodiment, information related to a modification to a reference list is information about a change in reference images assigned to a reference list or information about a method of changing a reference order.

According to an aspect of an exemplary embodiment, the LC-related information determination unit 12 may set LC modification-related information about an LC reference list, in units of slices.

According to an aspect of an exemplary embodiment, the LC-related information determination unit 12 may set at least one from among L0 modification-related information about the reference lists L0 and L1 modification-related information about the reference list L1, and LC modification-related information, in units of slices.

The video prediction encoding apparatus 10 may output prediction information and reference information. Also, according to an aspect of an exemplary embodiment, the video prediction encoding apparatus 10 may output or transmit LC-related information, L0-related information, and L1-related information set by the LC-related information determination unit 12.

According to an aspect of an exemplary embodiment, the video prediction encoding apparatus 10 may skip setting and transmitting LC flag information indicating whether an LC reference list is to be made by using at least one reference image from among the reference images included in the reference lists L0 and L1.

According to an aspect of an exemplary embodiment, the video prediction encoding apparatus 10 may transmit LC default number information together with parameters of a current picture. According to an aspect of an exemplary embodiment, the video prediction encoding apparatus 10 may transmit LC default number information together with parameters of a current slice. Also, according to an aspect of an exemplary embodiment, the video prediction encoding apparatus 10 may transmit LC modification-related information together with parameters of a current slice.

For example, the video prediction encoding apparatus 10 may signal LC default number information in units of pictures by using a picture parameter set (PPS). For example, the video prediction encoding apparatus 10 may signal LC active number information and LC modification-related information in units of pictures by using a sequence parameter set (SPS).

According to an aspect of an exemplary embodiment, the prediction encoder 14 determines reference information representing at least one reference image by predicting an image. The prediction encoder 14 may determine a prediction error between a current image and a reference image by predicting the current image.

The video prediction encoding apparatus 10 may be capable of expressing an image by using prediction information instead of the entire data of the image, and may thus be used to perform video encoding for compression encoding video so as to reduce the amount of data of the video to be stored or transmitted/received.

According to an aspect of an exemplary embodiment, the video prediction encoding apparatus 10 may be included in or operated interactively with the video encoder 15, which encodes video based on coding units obtained by spatially dividing an image of the video, to perform prediction encoding to encode video. Otherwise, each of the coding units may split into prediction units and partitions to prediction encode the coding units, and prediction encoding may be performed based on the prediction units and the partitions.

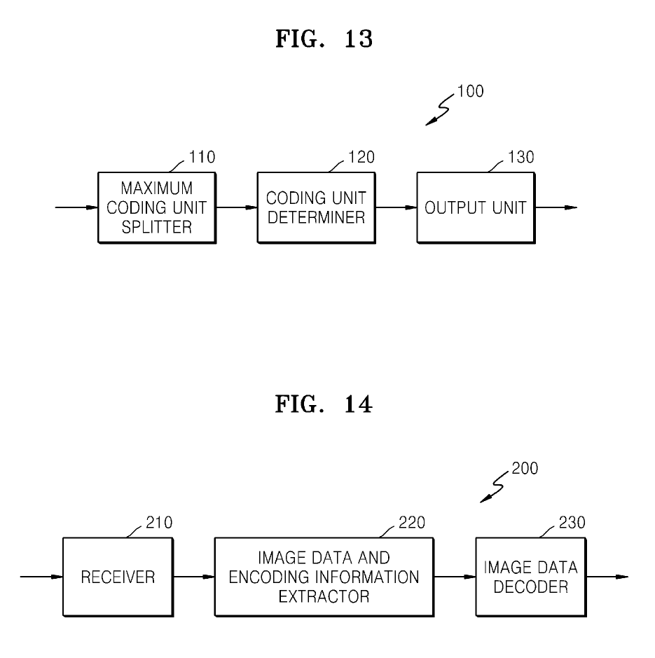

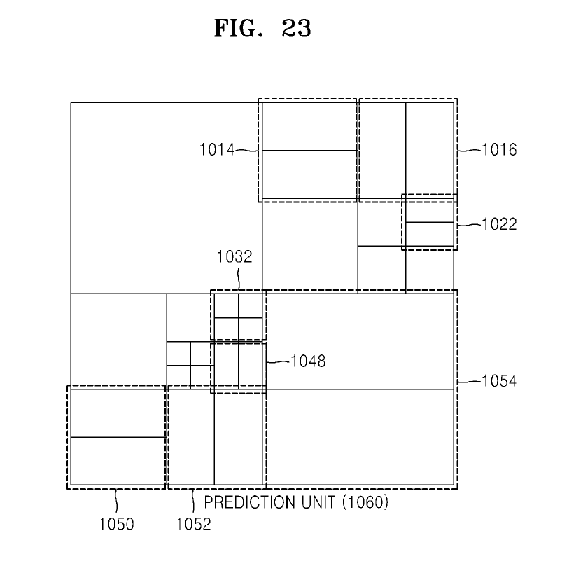

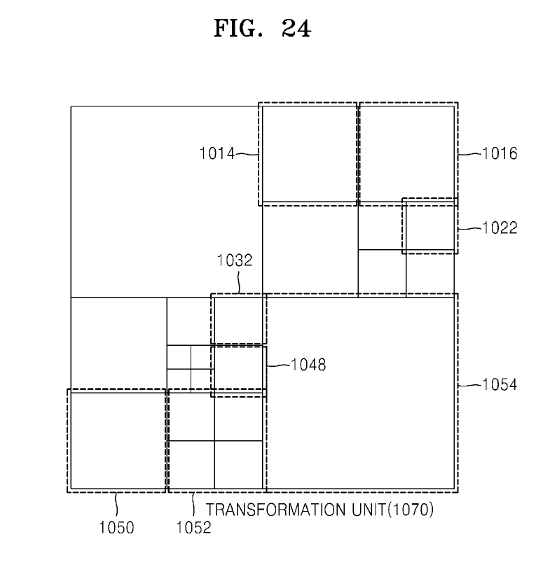

According to an aspect of an exemplary embodiment, examples of a coding unit may include not only blocks each having a fixedly determined shape but also coding units having a tree structure. Coding units having a tree structure and prediction units and partitions thereof according to an aspect of an exemplary embodiment are described in detail with reference to FIGS. 13 to 27 below.

According to an aspect of an exemplary embodiment, the video prediction encoding apparatus 10 may output a prediction error, i.e., a residual component, with respect to a reference image by prediction encoding image data of image blocks or coding units. The video encoder 15 may perform transformation and quantization on the residual component to produce a quantized transformation coefficient, perform entropy encoding on symbols, such as the transformation coefficient, reference information, and coding information, and then output a bitstream. According to an aspect of an exemplary embodiment, the video encoder 15 may encode symbols including LC-related information, L0-related information, and L1-related information and then output a result of the encoding.

The video encoder 15 may reproduce an image in a spatial domain by performing inverse quantization, inverse transformation, and prediction compensation on the transformation coefficient, and perform loop filtering to reproduce the original image in the spatial domain. The reproduced image may be used as a reference image to predict a subsequent image. That is, the prediction encoder 14 according to an aspect of an exemplary embodiment may refer to the image reproduced by the video encoder 15, based on the reference lists L0 and L1, and the LC reference list, so as to perform bi-prediction on a current image that is a B type slice. The prediction encoder 14 may determine reference information and a prediction error by performing prediction encoding as described above.

Thus, the video encoder 15 may perform compression encoding, based on a result of prediction encoding performed by the video prediction encoding apparatus 10.

According to an aspect of an exemplary embodiment, the video encoder 15 may encode video based on prediction encoding by being operated interactively with a video encoding processor therein (not shown) or an external video encoding processor to output a result of encoding the video. According to an aspect of an exemplary embodiment, the video encoding processor included in the video encoder 15 may be an additional processor, or may include a case where the video prediction encoding apparatus 10, a central processing unit (CPU), or a graphic processing unit drives a video encoding processing module to perform basic video encoding functions.

FIG. 2 is a block diagram of a video prediction decoding apparatus 20 according to an aspect of an exemplary embodiment.

The video prediction decoding apparatus 20 includes an LC-related information decoder 22 and a prediction decoder 24.

According to an aspect of an exemplary embodiment, the video prediction encoding apparatus 10 may further include a central processor (not shown) that controls overall operations of the LC-related information decoder 22 and the prediction decoder 24. Otherwise, the LC-related information decoder 22 and the prediction decoder 24 may be respectively operated by processors corresponding thereto (not shown) and the processors may operate interactively with each other, thereby operating the video prediction decoding apparatus 20. Otherwise, the LC-related information decoder 22 and the prediction decoder 24 may be operated under control of an external processor (not shown) of the LC-related information decoder 22 and the prediction decoder 24 according to an aspect of an exemplary embodiment.

According to an aspect of an exemplary embodiment, the video prediction decoding apparatus 20 may further include at least one data storage unit (not shown) that stores data input to or output from the LC-related information decoder 22 and the prediction decoder 24. The video prediction decoding apparatus 20 may further include a memory controller (not shown) that controls data to be input to or output from the data storage unit.

According to an aspect of an exemplary embodiment, the video prediction decoding apparatus 20 may extract encoding information for decoding an image by parsing a received bitstream. The video prediction decoding apparatus 20 may extract reference information representing at least one reference image for predicting an image and prediction information including a prediction error by parsing a received bitstream.

According to an aspect of an exemplary embodiment, the LC-related information decoder 22 may decode the extracted reference information to determine the at least one reference image based on the reference information. Also, LC-related information decoder 22 may decode the extracted prediction information to determine the prediction error based on the prediction information.

In detail, according to an aspect of an exemplary embodiment, the LC-related information decoder 22 may determine a prediction error between a current image and reference image and reference information, based on prediction information extracted to decode a current image. The LC-related information decoder 22 may decode information about a reference list from the extracted encoding information. For example, the LC-related information decoder 22 may decode L0-related information, L1-related information, and LC-related information.

According to an aspect of an exemplary embodiment, the video prediction decoding apparatus 20 may not need to extract LC flag information from a received bitstream or the LC-related information decoder 22 may not need to decode the LC flag information.

According to an aspect of an exemplary embodiment, the LC-related information decoder 22 may decode LC default number information, LC active number information, and LC modification-related information, as LC-related information. According to an aspect of an exemplary embodiment, the LC-related information decoder 22 may decode the LC default number information for a current picture. According to an aspect of an exemplary embodiment, the LC-related information decoder 22 may decode LC active number information for a current slice. Also, according to an aspect of an exemplary embodiment, the LC-related information decoder 22 may decode LC modification-related information for a current slice.

According to an aspect of an exemplary embodiment, the LC-related information decoder 22 may decode information about LC default number information together with parameters for a current picture. For example, the LC-related information decoder 22 may decode LC default number information from a signaled PPS for each of pictures.

According to an aspect of an exemplary embodiment, the LC-related information decoder 22 may decode LC active number information together with parameters for a current slice. Also, according to an aspect of an exemplary embodiment, the LC-related information decoder 22 may decode LC modification-related information for a current slice. For example, the LC-related information decoder 22 may decode LC active number information and LC modification-related information from a signaled SPS for each of sequences.

According to an aspect of an exemplary embodiment, the LC-related information decoder 22 may determine an LC reference list including at least one reference image from among reference images included in reference lists L0 and L1 so as to perform bi-prediction on each of B type slices.

According to an aspect of an exemplary embodiment, the LC-related information decoder 22 may determine a default number of active reference images assigned to a LC reference list, from LC default number information for each of pictures.

According to an aspect of an exemplary embodiment, the prediction decoder 24 may determine an LC reference list including at least one reference image from among reference images included in reference lists L0 and L1, based on LC default number information. The prediction decoder 24 may perform prediction decoding on an image that is a B type slice, based on the at least one reference image assigned to the determined LC reference list.

According to an aspect of an exemplary embodiment, the LC-related information decoder 22 may determine whether a number of active reference images assigned to an LC reference list for a current image is arbitrarily changed, in units of slices, based on LC active number modification flag information. Also, according to an aspect of an exemplary embodiment of the LC-related information decoder 22 may decode LC active number modification flag information and then determine whether the number of active reference images assigned to the LC reference list is arbitrarily changed, in units of slices, based on reference list active number modification flag information.

For example, according to an aspect of an exemplary embodiment, the LC-related information decoder 22 may determine whether a number of active reference images for a current image is arbitrarily changed, in units of slices, based on reference list active number modification flag information. The LC-related information decoder 22 may decode the reference list active number modification flag information, and may decode LC active number information together with at least one of L0 active number information and L1 active number information when it is determined that a number of reference images included in a reference list is changed.

According to an aspect of an exemplary embodiment, if it is determined based on the LC active number modification flag information that the number of active reference images is arbitrarily changed, then the LC-related information decoder 22 may determine a current number of active reference images assigned to the LC reference list after the number of active reference images assigned to the LC reference list is arbitrarily changed, from LC active number information.

According to an aspect of an exemplary embodiment, the LC-related information decoder 22 may decode information about reference images included in an LC reference list or information about a method of changing a reference order in which the reference images are to be referred, from LC modification-related information, in units of slices.

According to an aspect of an exemplary embodiment, the LC-related information decoder 22 may decode LC default number information together with at least one of L0 default number information and L1 default number information for a current image, in units of pictures.

According to an aspect of an exemplary embodiment, the LC-related information decoder 22 may decode LC modification-related information together with at least one of L0 modification-related information and L1 modification-related information for a current image, in units of slices.

According to an aspect of an exemplary embodiment, the prediction decoder 24 may construct an LC reference list, based on reference images included in reference lists L0 and L1, even when the LC-related information decoder 22 does not decode LC flag information.

According to an aspect of an exemplary embodiment, the prediction decoder 24 may determine at least one reference list including reference images and information about a reference order in which the reference images are to be referred so as to perform bi-prediction on an image that is a B type slice, based on reference information decoded by the LC-related information decoder 22. For example, in order to perform bi-prediction on a current image that is a B type slice, the prediction decoder 24 may obtain a reproduced image of the current image by performing motion compensation on the current image by referring to reference images included in a reference list L0, a reference list L1, and an LC reference list based on the reference order. The reproduced image may be output as a resultant image obtained by performing prediction decoding. The reproduced image may be used as a reference image for performing motion compensation on a subsequent image.

The video prediction decoding apparatus 20 is capable of reproducing an image by using prediction information, instead of the entire data of the image, and may thus be used for video decoding to compression encoding of the video to reduce the amount of data of the video to be stored or transmitted/received.

According to an aspect of an exemplary embodiment, the video prediction decoding apparatus 20 may be included in or operated interactively with a video decoder (not shown), which decodes video based on blocks or coding units obtained by splitting an image of the video into spatial regions, to perform prediction decoding to decode video. Also, a coding unit may split into prediction units and partitions to perform prediction decoding on the coding unit, and prediction decoding may be performed on the prediction units and the partitions.

According to an aspect of an exemplary embodiment, examples of a coding unit may include not only blocks each having a fixedly determined shape but also coding units having a tree structure. Coding units having a tree structure and prediction units and partitions thereof according to an aspect of an exemplary embodiment are described in detail with reference to FIGS. 13 to 27 below.

According to an aspect of an exemplary embodiment, when a bitstream obtained by encoding video is input to the video prediction decoding apparatus 20, the video prediction decoding apparatus 20 may parse the bitstream to extract encoded symbols therefrom. A prediction error with respect to a reference image may be restored by performing entropy decoding, inverse quantization, and inverse transformation on the encoded symbols. An image in a spatial domain may be reproduced by performing prediction compensation by using the prediction error and reference information, and loop filtering may be performed on the reproduced image. Thus, a video decoder (not shown) may perform compression decoding, based on a result of prediction decoding performed by the video prediction decoding apparatus 20.

According to an aspect of an exemplary embodiment, the video prediction decoding apparatus 20 may decode video based on prediction decoding by being operated interactively with a video decoding processor therein (not shown) or an external video decoding processor to output a result of decoding the video. According to an aspect of an exemplary embodiment, the video decoding processor included in the video prediction decoding apparatus 20 may be an additional processor, or may include a case where the prediction decoder 24 or a graphic processing unit drives a video decoding processing module to perform basic video decoding functions.

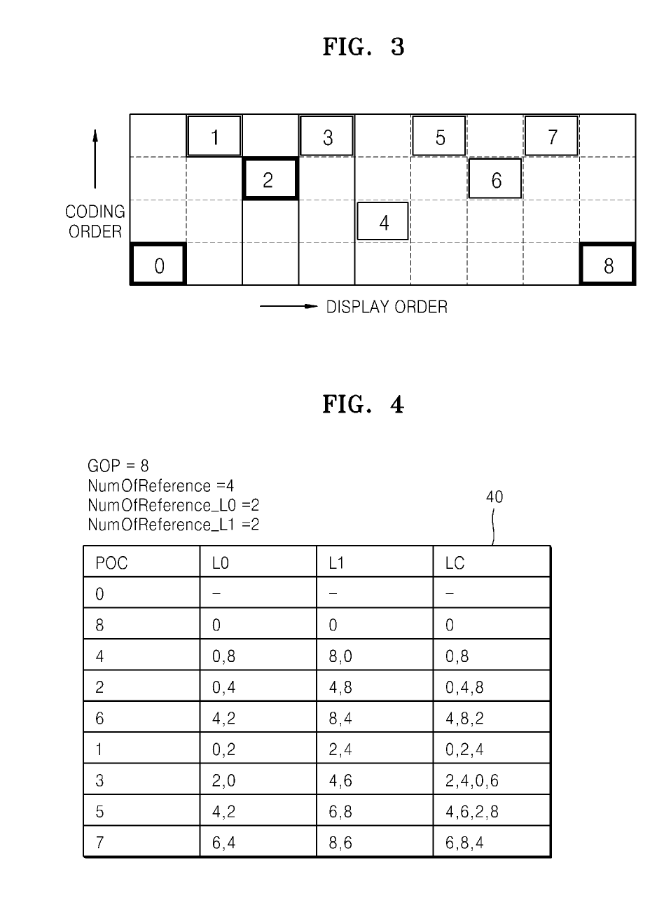

FIG. 3 illustrates an order of displaying a picture sequence of video and an order of coding the picture sequence, according to an aspect of an exemplary embodiment.

Indexes assigned to pictures 0, 1, 2, 3, 4, 5, 6, 7, and 8 denote an order in which these pictures are to be displayed. Vertical levels of the pictures 0, 1, 2, 3, 4, 5, 6, 7, and 8 denote an order in which these pictures are to be coded. For example, the pictures 0 and 8 are first coded, the picture 4 is coded, the pictures 2 and 6 are coded, and finally, the pictures 1, 3, 5, and 7 are coded. From among pictures having the same level, i.e., the pictures 0 and 8, the pictures 2 and 6, and the pictures 1, 3, 5, and 7, a picture that is to be first displayed may first be coded.

FIG. 4 is a table 40 showing a relation among reference lists L0 and L1, and an LC reference list of each of pictures that are B type slices included in the picture sequence of FIG. 3, according to an aspect of an exemplary embodiment.

In FIG. 3, the pictures 0, 1, 2, 3, 4, 5, 6, 7, and 8 are pictures belonging to a group of pictures (GOP) consisting of eight pictures. For example, if the picture 0 and 8 are I-type slices, the picture 0 that is a first I-type slice and the pictures 1, 2, 3, 4, 5, 6, and 7 preceding the picture 8 that is a subsequent I-type slice may form a GOP together.

A maximum of four images may be referred in the case of a picture that is a B type slice, and each of the reference lists L0 and L1 may include a maximum of two reference images.

Referring to the table 40, indexes of a current picture are arranged in a decoding order in a column POC, and indexes of reference images assigned to the reference lists L0 and L1 and the LC reference list for the current picture are arranged in columns L0, L1, and LC.

Specifically, images, the indexes of which are smaller than that of the current image may be assigned to the reference list L0 and images, the indexes of which are greater than that of the current image may be assigned to the reference list L1, from among images coded before the current picture. Also, a reference order in which images are to be referred may be determined in such a manner that an image closest to the current may be first referred and an image farthest from the current image may be last referred image from among the images, the indexes of which are smaller/greater than that of the current picture.

In the case of the picture 6, the pictures 0, 2, 4, and 8 are images coded before the picture 6, and the pictures 4 and 2 that precede the picture 6 and are closer to the picture 6 may thus be assigned to the reference list L0 of the picture 6 from among the pictures 0, 2, 4, and 8.

Additionally, if the number of images, the indexes of which are smaller/greater than that of a current picture is less than ‘2’ from among images coded before the current picture, then a picture displayed most adjacent to the displayed current picture may be selected as a reference image to be assigned to the reference list L0 (reference list L1) from among the images that are coded before the current picture and the indexes of which are smaller/greater than that of the current picture.

In the case of the picture 4, although the pictures 0 and 8 are coded before the picture 4, only the picture 0 precedes the picture 4 from among the pictures 0 and 8. Thus, the reference list L0 of the picture 4 may include not only the preceding picture 0 but also the picture 8 following the picture 4. Similarly, the reference list L1 of the picture 4 may include not only the following picture 8 but also the preceding picture 0.

In the case of the picture 6, although the pictures 0, 2, 4, and 8 are coded before the picture 6, only the picture 0 follows the picture 6 from among the pictures 0, 2, 4, and 8. Thus, the reference list L1 of the picture 6 may include not only the following picture 8 but also the picture 4 that precedes and is closer to the picture 4.

The LC reference list may include a combination of reference images assigned to the reference list L0 and reference images assigned to the reference list L1. Thus, the relationship among a number N_L0 of the reference images of the reference list L0, a number N_L1 of the reference images of the reference list L1, and a number N_LC of the reference images of the LC reference list may be determined by:

N_LC=[0,(N_{—}L0+N_{—}L1] [Equation A]

In other words, the number N_LC of the reference images of the LC reference list may be equal to or greater than ‘0’, and may be less than or equal to the sum of the number N_L0 of the reference images of the reference list L0 and the number N_L1 of the reference images of the reference list L1.

Referring to table 40, the LC reference list may include a maximum of four reference images, but there is the possibility that some of the pictures 8, 4, 2, 6, 1, and 7 may be assigned to both of the reference lists L0 and L1. In this case, the number of reference images assigned to the LC reference list including a combination of the reference images assigned to the reference lists L0 and L1 may be less than ‘4’.

Thus, reference images assigned to the LC reference list and the number of the reference images may be determined dependently on the reference images assigned to the reference lists L0 and L1.

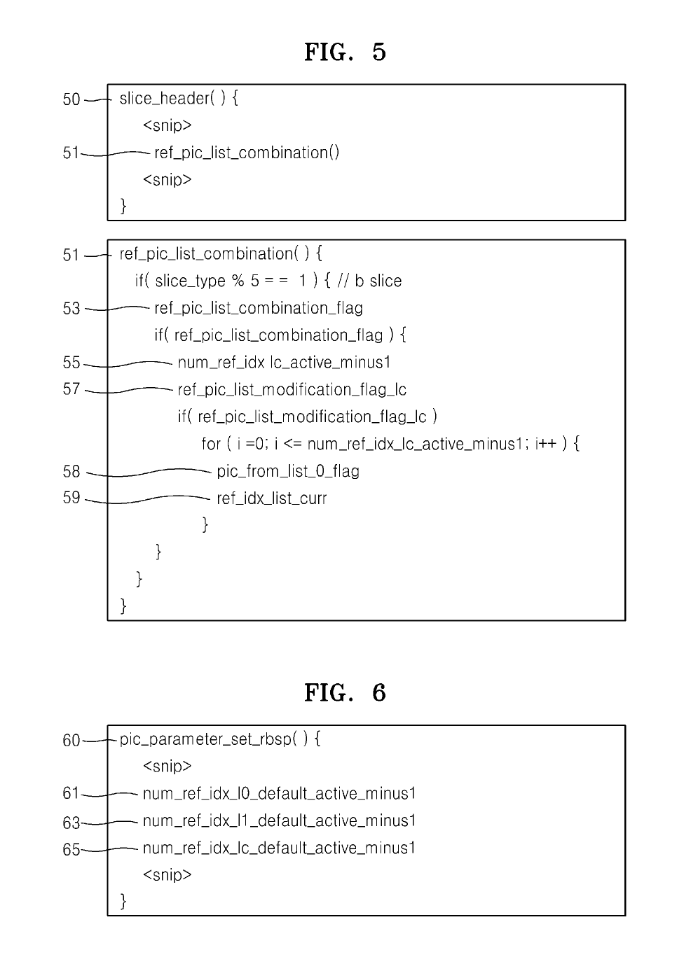

According to an aspect of an exemplary embodiment, the video prediction encoding apparatus 10 may transmit L0 related information, L1 related information, and LC related information. According to an aspect of an exemplary embodiment, the video prediction decoding apparatus 20 may decode encoding information extracted from a received bitstream according to a syntax, and may also decode the L0 related information, the L1 related information, and the LC related information according to the syntax. FIGS. 5 to 10 illustrate syntaxes of L0 related information, L1 related information, and LC related information, according to an aspect of an exemplary embodiment.

FIG. 5 illustrates syntax of LC related information set in units of slices, according to an aspect of an exemplary embodiment.

A slice header slice_header( ) 50 may be set in units of slices. Each of the slice headers slice_header( ) 50 may include various information for encoding/decoding a current slice. Thus, the various included in the slice header slice_header( ) 50 may be set with respect to the current slice. For example, the slice header slice_header( ) 50 may include LC related information ref_pic_list_combination( ) 51. The LC related information ref_pic_list_combination( ) 51 may be information set with respect to an LC reference list for the current slice.

The LC related information ref_pic_list_combination( ) 51 may include LC flag information ref_pic_list_combination_flag 53, LC active number information num_ref_idx lc_active_minus1 55, and LC modification-related information. According to an aspect of an exemplary embodiment, the LC modification-related information may include LC modification flag information ref_pic_list_modification_flag_lc 57, L0/L1 image flag information pic_from_list_0_flag 58, current index information ref_idx_list_curr 59, and so on.

For example, if it is determined that an LC reference list includes a combination of references images included in a reference list L0/L1, based on the LC flag information 53, then a current number of active reference images assigned to the LC reference list according to the LC active number information num_ref_idx lc_active_minus1 55 may be decoded.

When the LC reference list is modified according to the LC modification flag information ref_pic_list_modification_flag_lc 57, at least one reference image may be newly assigned to the LC reference list. In other words, the LC reference list may be assigned new reference images, the number of which is equal to the current number of active reference images assigned to the LC reference list according to the LC active number information num_ref_idx lc_active_minus1 55. Whether each of the newly assigned reference images is a reference image from among the reference images being originally included in the reference list L0 or L1, is determined based on the L0/L1 image flag information pic_from_list_0_flag 58. Also, the indexes of the reference images being originally included in the reference lists L0 and L1 may be checked based on the current index information ref_idx_list_curr 59.

Thus, referring to FIG. 5, if the LC related information ref_pic_list_combination( ) 51 is included in the slice header slice_header( ) 50, then the LC flag information ref_pic_list_combination_flag 53 is transmitted/decoded in units of slices. Also, if the LC reference list is obtained by combining the reference images of the reference list L0/L1 according to the LC flag information 53 transmitted/decoded in units of slices, separately from L0/L1 related information, then the LC active number information num_ref_idx lc_active_minus1 55 and the LC modification-related information is transmitted/read, irrespective of the L0/L1 related information.

FIG. 6 illustrates syntax of reference list default number information according to an aspect of an exemplary embodiment.

According to an aspect of an exemplary embodiment, PPS information pic_parameter_set_rbsp( ) 60 may include L0 default number information num_ref_idx_l0_default_active_minus1 61, L1 default number information num_ref_idx_l1_default_active_minus1 63, and LC default number information num_ref_idx_lc_default_active_minus1 65.

Thus, a default number of active reference images assigned to each of a reference list L0 and a reference list L1 and a default number of active reference images assigned to an LC reference list may be set in units of pictures. Also, LC default number information about each of the pictures may be included in the PPS information pic_parameter_set_rbsp( ) 60 of each of the pictures. Since the PPS information pic_parameter_set_rbsp( ) 60 of each of the pictures, which is extracted from a received video stream, includes the LC default number information, the LC default number information about a current picture may be decoded from the PPS information pic_parameter_set_rbsp( ) 60 of each of the pictures. Thus, the default number of active reference images assigned to each of the reference lists L0 and L1 and the LC reference list may be determined by decoding L0 default number information, L1 default number information, and LC default number information in units of pictures.

Referring to FIG. 5, the LC flag information ref_pic_list_combination_flag 53 is set and transmitted/decoded in units of slices, whereas referring to FIG. 6, the LC default number information num_ref_idx_lc_default_active_minus1 65 is set in units of pictures so that the structure of the LC reference list may be analogically interpreted. Thus, according to an aspect of an exemplary embodiment, since the LC default number information num_ref_idx_lc_default_active_minus1 65 is set in units of pictures, the flag information ref_pic_list_combination_flag 53 does not need to be transmitted and decoded in units of slices.

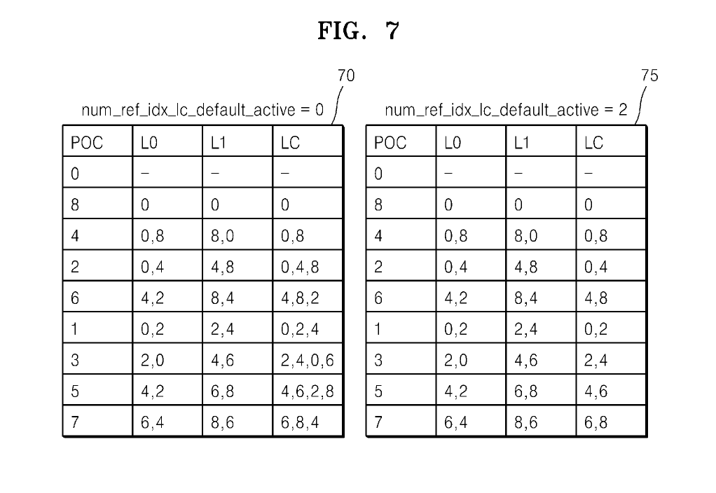

FIG. 7 illustrates LC reference lists set according to LC default number information num_ref_idx_lc_default_active, according to an aspect of an exemplary embodiment.

According to an aspect of an exemplary embodiment, the LC default number information num_ref_idx_lc_default_active may define a default number of active reference images assigned to an LC reference list.

A first table 70 and a second table 75 show a change in a default number of active reference images assigned to the LC reference list, according to a value of the LC default number information num_ref_idx_lc_default_active.

Similar to the table 40 of FIG. 4, in the first table 70 and the second table 75, indexes of a current picture are arranged according to a decoding order in a column POC. Also, in the first and second tables 70 and 75, indexes of reference images assigned to reference lists L0 and L1 and an LC reference list for a current picture are arranged in columns L0, L1, and LC.

For example, the first table 70 shows reference images assigned to the reference lists L0 and L1 and the LC reference list when the LC default number information num_ref_idx_lc_default_active is set to ‘0’. According to an aspect of an exemplary embodiment, when the LC default number information num_ref_idx_lc_default_active is set to ‘0’, a default number of active reference images assigned to the LC reference list may not be additionally set and may instead be automatically determined according to states of the reference lists L0 and L1. Thus, in the first table 70, each of LC reference lists for a current picture may include a combination of all reference images assigned to the reference list L0 and the reference list L1.

For example, the second table 80 shows reference images assigned to the reference lists L0 and L1 and the LC reference list when the LC default number information num_ref_idx_lc_default_active is set to ‘2’. According to an aspect of an exemplary embodiment, when the LC default number information num_ref_idx_lc_default_active is set to a value other than ‘0’, a default number of active reference images assigned to the LC reference list may be determined to be equal to the value of the LC default number information num_ref_idx_lc_default_active. Thus, since in the second table 75, the default number of active reference images assigned to the LC reference list is determined to be ‘2’, an LC reference list for a current picture may include only two reference images close to the current picture from among all the reference images assigned to the reference list L0 and the reference list L1.

Although the PPS information pic_parameter_set_rbsp( ) 60 has been described above with reference to FIG. 6 as including default number information for the reference lists L0 and L1 and the LC reference list, the exemplary embodiments not limited thereto. For example, according to another aspect of an exemplary embodiment, the default number information for reference lists L0 and L1 and the LC reference list may be included in sequence parameter set (SPS) information, adaptation parameter set (APS) information, a parameter set, a slice header, a sequence header, or the like.

Thus, the default number information for reference lists L0 and L1 and the LC reference list according to another aspect of an exemplary embodiment may be transmitted/decode together with sequence parameters, adaptation parameters, or any other parameters. The default number information for reference lists L0 and L1 and the LC reference list according to another aspect of an exemplary embodiment may be set in units of slices and be transmitted/decode together with various parameters for each of the slices, or may be set in units of sequences and be transmitted/decode together with various parameters for each of the sequences.

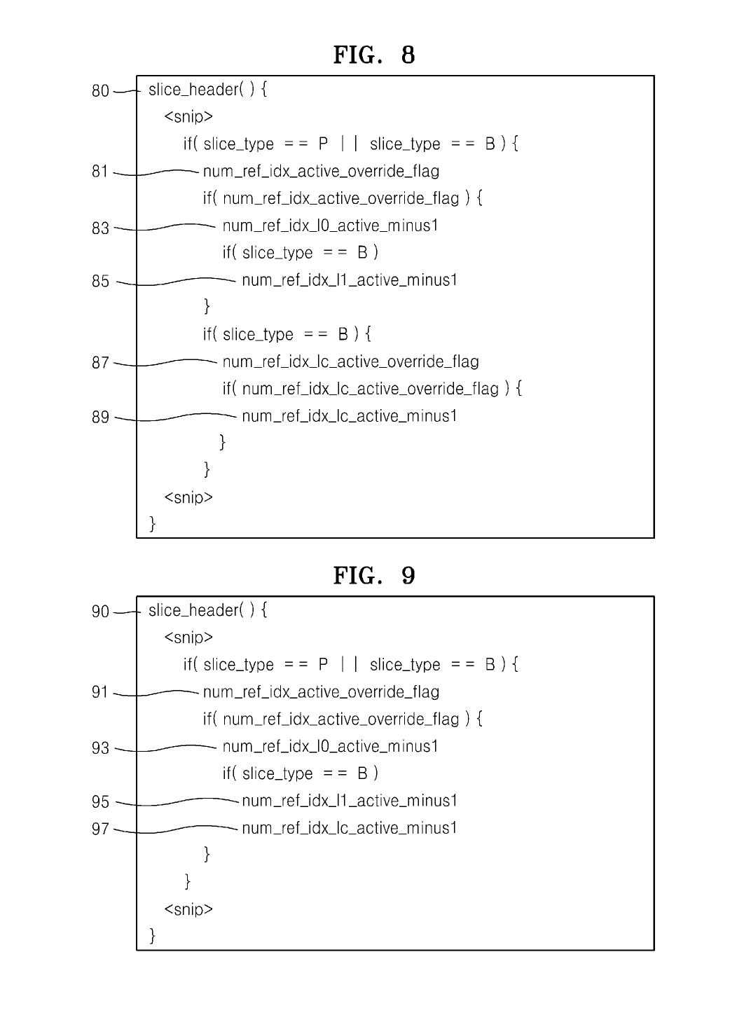

FIGS. 8 and 9 illustrate syntaxes of reference list active number related information according to various aspects of exemplary embodiments.

Referring to FIGS. 8 and 9, each of slice headers slice_header( ) 80 and 90 includes L0 active number related information, L1 active number related information, and LC active number related information.

Specifically, in the case of the slice header slice_header( ) 80 of FIG. 8, if a current slice is a P or B type slice, the L0 active number related information and the L1 active number related information may be decoded.

First, reference list active number modification flag information num_ref_idx_active_override_flag 81 may be decoded. Based on the reference list active number modification flag information num_ref_idx_active_override_flag 81, whether a number of active reference images assigned to a reference list is arbitrarily changed may be determined.

If it is determined based on the reference list active number modification flag information num_ref_idx_active_override_flag 81 that a number of active reference images assigned to a reference list is arbitrarily changed, then L0 active number information num_ref_idx_l0_active_minus1 83 may be decoded. A current number of active reference images assigned to a reference list L0 may be determined, based on the L0 active number information num_ref_idx_l0_active_minus1 83.

If it is determined that a number of active reference images assigned to a reference list is arbitrarily changed and the current slice is a B type slice, then L1 active number information num_ref_idx_l1_active_minus1 85 may be decoded. Based on the L1 active number information 85, a current number of active reference images assigned to a reference list L1 may be determined.

If the current slice is a B type slice regardless of the L0 active number related information and the L1 active number related information, the LC active number related information may be decoded. First, LC active number modification flag information num_ref_idx_lc_active_override_flag 87 may be decoded. Whether a number of active reference images assigned to an LC reference list is arbitrarily changed may be determined based on the LC active number modification flag information 81.

If it is determined based on the reference list active number modification flag information num_ref_idx_active_override_flag 81 that the number of active reference images assigned to an LC reference list is arbitrarily changed LC reference list, then LC active number information num_ref_idx_lC_active_minus1 89 may be decoded. Based on the LC active number information num_ref_idx_lC_active_minus1 89, a current number of active reference images assigned to the LC reference list may be determined.

In the case of the slice header slice_header( ) 90 of FIG. 9, if a current slice is a P or B type slice, reference list active number modification flag information num_ref_idx_active_override_flag 91 may be decoded. If it is determined based on the reference list active number modification flag information 91 that a number of active reference images assigned to a reference list is arbitrarily changed, then L0 active number information num_ref_idx_l0_active_minus1 93 may be decoded and a current number of active reference images assigned to a reference list L0 may be determined.

If it is determined that a number of active reference images assigned to a reference list is arbitrarily changed and the current slice is a B type slice, then L1 active number information num_ref_idx_l1_active_minus1 95 and LC active number information num_ref_idx_lc_active_minus1 97 may be decoded together. A current number of active reference images assigned to a reference list L1 may be determined based on the L1 active number information num_ref_idx_l1_active_minus1 95, and a current number of active reference images assigned to an LC reference list may be determined based on the LC active number information num_ref_idx_lc_active_minus1 97.

Thus, referring to FIGS. 8 and 9, active number related information for each of the reference lists L0 and L1 and the LC reference list may be set in units of slices. Also, in the slice header slice_header( ) 50 according to the embodiment described above with reference to FIG. 5, the LC active number information num_ref_idx lc_active_minus1 55 is transmitted/decoded in units of slices, separately from active number related information for the reference list L0/L1. However, in the slice headers slice_header( ) 80 and 90 according to the embodiments described above with reference to FIGS. 8 and 9, the active number related information 87, 89, and 97 for the LC reference list may be transmitted/decoded together with the active number related information 81, 83, 85, 91, 93, and 95 for the reference list L0/L1.

Each of the LC active number information 89 and 97 of FIGS. 8 and 9 may directly represent a current number of active reference images assigned to the LC reference list. LC active number information according to another aspect of an exemplary embodiment may represent the difference between current numbers of active reference images assigned to the reference lists L0 and LC, the difference between current numbers of active reference images assigned to the reference lists L1 and LC, or the difference between the current number of active reference images assigned to the LC reference list and the sum of the current number of active reference images assigned to the reference lists L0 and L1.

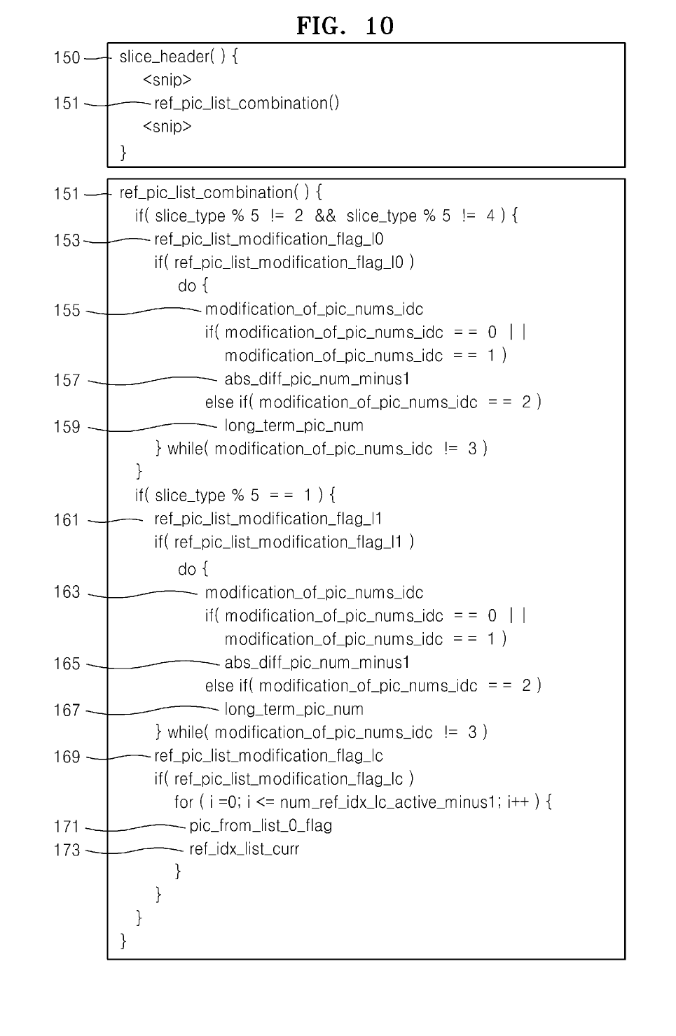

FIG. 10 illustrates syntax of reference list modification information according to an aspect of an exemplary embodiment.

Referring to FIG. 10, a slice header slice_header( ) 150 includes reference list modification-related information ref_pic_list_modification( ) 151.

According to an aspect of an exemplary embodiment, the reference list modification-related information ref_pic_list_modification( ) 151 may include L0 modification-related information, L1 modification-related information, and LC modification-related information for a current slice.

First, if the current slice is a P or B type slice, L0 modification flag information ref_pic_list_modification_flag_l0 153 may be decoded. Whether reference images assigned to a reference list L0 are to be changed may be determined based on the L0 modification flag information ref_pic_list_modification_flag_l0 153.

If it is determined based on the L0 modification flag information ref_pic_list_modification_flag_l0 153 that the reference images assigned to the reference list L0 are to be changed, then reference image modification information modification_of_pic_nums_idc 155 may be decoded. Based on the reference image modification information modification_of_pic_nums_idc 155, reference image number difference information abs_diff_pic_num_minus1 157 or long-term reference image number information long_term_pic_num 159 may be determined.

If the current slice is a B type slice, L1 modification flag information ref_pic_list_modification_flag_l1 161 may be decoded. Whether reference images assigned to a reference list L1 are to be changed may be determined based on the L1 modification flag information ref_pic_list_modification_flag_l1 161. If it is determined based on the L1 modification flag information ref_pic_list_modification_flag_l1 161 that the reference images assigned to the reference list L1 are to be changed, then reference image modification information modification_of_pic_nums_idc 163 may be decoded. Based on the reference image modification information modification_of_pic_nums_idc 163, reference image number difference information abs_diff_pic_num_minus1 165 or long-term reference image number information long_term_pic_num 167 may be determined.

Each of the reference image number difference information abs_diff_pic_num_minus1 157 and 165 represents the difference between a number of a reference image to be assigned to a current index of a current reference list and a predicted value of the number of the reference image. Each of the long-term reference image number information long_term_pic_num 159 and 167 represents a number of a long-term image to be assigned to the current index of the current reference list. The long-term image may include reference frames or reference fields. The long-term reference image number information long_term_pic_num 159 may indicate one of the reference frames or one of the reference fields.

Thus, a number of a reference image that is to be assigned to the current reference list may be determined by using the reference image number difference information abs_diff_pic_num_minus1 157 and 165 or the long-term reference image number information long_term_pic_num 159 and 167, based on the reference image modification information modification_of_pic_nums_idc 155 and 163. As a reference image that is to be moved and assigned to the current index of the current reference list is changed, reference images assigned to the current reference image or a reference order in which the reference images are to be referred to may also change.

If the current slice is a B type slice, LC modification flag information ref_pic_list_modification_flag_lc 169 may be decoded. If it is determined based on the LC modification flag information ref_pic_list_modification_flag_lc 169 that the LC reference list is changed, then L0/L1 image flag information pic_from_list_0_flag 171 and current index information ref_idx_list_curr 173 may be decoded for each of reference images assigned to the LC reference list. Whether a reference image that is to be currently assigned is a reference image from among the reference images assigned to the reference list L0 or L1 may be determined, based on the L0/L1 image flag information pic_from_list_0_flag 171. The index of a reference image that is to be currently assigned from among reference images included in a reference list may be checked, based on the current index information ref_idx_list_curr 173.

Thus, a reference image that is to be moved and assigned to a current index of a current LC reference list may be selected from among the reference images included in the reference list L0 or L1, but may be replaced with another reference image, or a reference order in which reference images are to be referred may be changed.

Thus, referring to FIG. 10, modification-related information about reference images assigned to each of the reference lists L0 and L1 and the LC reference list may be set in units of slices. Also, in the embodiment of FIG. 5, the LC modification-related information 57, 58, and 59 are transmitted/decoded in units of slices, separately from information related a modification to reference images assigned to the reference list L0/L1. On the other hand, in the slice header slice_header( ) 150 of the embodiment of FIG. 10, the information 169, 171, and 173 related to a modification to the reference images assigned to the LC reference list may be transmitted/decoded together with the information 153, 155, 157, 159, 161, 163, 165, and 167 related to a modification to the reference images assigned to the reference list L0/L1.

The slice headers slice_header( ) 80, 90, and 150 each including active number related information and modification-related information related to the reference lists L0 and L1 and the LC reference list according to various aspects of exemplary embodiments have been described above with respect to FIGS. 8 to 10, but the exemplary embodiments are not limited thereto. For example, active number related information and modification-related information related to the reference lists L0 and L1 and the LC reference list according to another aspect of an exemplary embodiment may be stored in adaptation parameter set (APS) information, a parameter set, a sequence parameter, or the like.

Thus, active number related information and modification-related information related to the reference lists L0 and L1 and the LC reference list according to another aspect of an exemplary embodiment may be transmitted/decoded together with adaptation parameters or any other parameters. Active number related information and modification-related information related to the reference lists L0 and L1 and the LC reference list according to another aspect of an exemplary embodiment may be set in units of sequences and may be transmitted and/or decoded together with various parameters for the sequences.

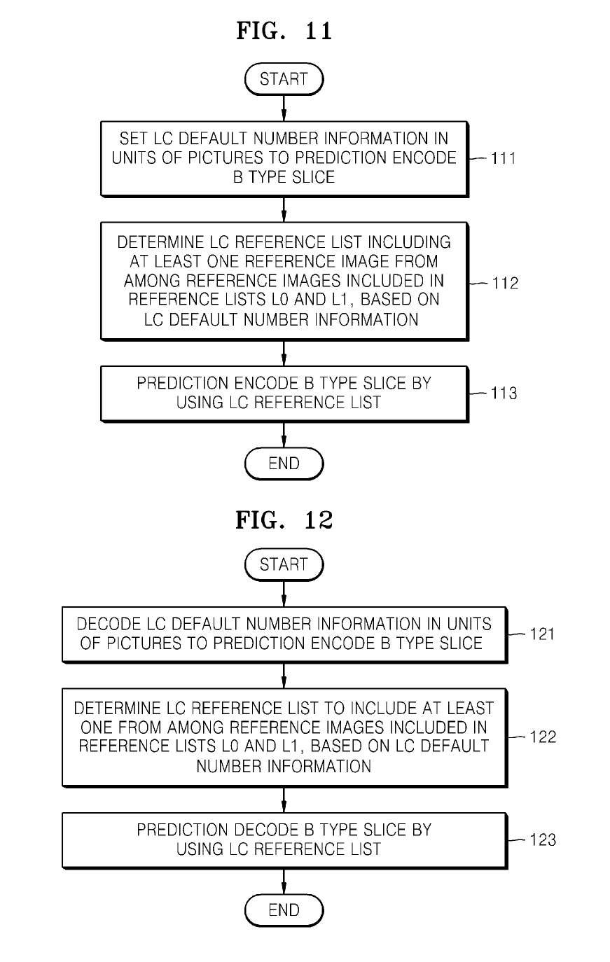

FIG. 11 is a flowchart illustrating a video prediction encoding method according to an aspect of an exemplary embodiment.

In operation 111, for an LC reference list for prediction encoding an image that is a B type slice, LC default number information may be set in units of pictures. Also, at least one of L0 default number information and L1 default number information, and LC default number information may be set together in units of pictures.

In operation 112, an LC reference list including at least one reference image from among reference images included in a reference list L0 and a reference list L1 may be determined, based on the LC default number information.

In operation 113, the image that is a B type slice may be prediction encoded by using the LC reference list determined in operation 112.

In a video prediction encoding method according to an aspect of an exemplary embodiment, it is possible to skip setting of LC flag information indicating whether the LC reference list is to be constructed using at least one reference image from among the reference images included in the reference list L0 and the reference list L1.

In operation 111, not only the LC default number information may be set in units of pictures but also LC active number related information may be set in units of slices.

According to an aspect of an exemplary embodiment, LC active number modification flag information and LC active number information may be set in units of slices, based on reference list active number modification flag information. Also, at least one of L0 active number information and L1 active number information and LC active number information may be set in units of slices, based on the reference list active number modification flag information.

According to an aspect of an exemplary embodiment, LC modification-related information may be set in units of slices. Also, at least one of L0 modification-related information and L1 modification-related information and LC modification-related information may be set in units of slices.

According to an aspect of an exemplary embodiment, LC default number information set for a current picture may be transmitted together with parameters for the current picture. According to an aspect of an exemplary embodiment, LC active number information set for a current slice may be transmitted together with parameters for the current slice. According to an aspect of an exemplary embodiment, LC modification-related information set for a current slice may be transmitted together with parameters for a current slice.

FIG. 12 is a flowchart illustrating a video prediction decoding method according to an aspect of an exemplary embodiment.

In operation 121, for an LC reference list for prediction decoding a B type slice, LC default number information indicating a default number of active reference images assigned to the LC reference list may be decoded in units of pictures. In a video prediction decoding method according to an aspect of an exemplary embodiment, when a video stream is received, the LC default number information may be extracted from the video stream together with parameters for a current picture and then be decoded. According to an aspect of an exemplary embodiment, at least one of L0 default number information and L1 default number information and the LC default number information may be decoded in units of pictures.

In operation 122, based on the LC default number information, the LC reference list may be determined to include at least one from among reference images included in a reference list L0 and a reference list L1.

In operation 123, the B type slice may be prediction decoded by using the LC reference list determined in operation 122.

In a video prediction decoding method according to an aspect of an exemplary embodiment, the LC reference list may be determined without having to decode LC flag information indicating whether the LC reference list is to be constructed using at least one from among the reference images included in the reference lists L0 and L1.

In addition to the LC default number information decoded in operation 121, LC active modification-related information may be decoded in units of slices. The LC active number information may be extracted from a received video stream together with parameters for a current slice and then be decoded. According to an aspect of an exemplary embodiment, LC active number modification flag information may be decoded based on reference list active number modification flag information. Also, the LC active number information may be decoded based on the LC active number modification flag information.

According to an aspect of an exemplary embodiment, the reference list active number modification flag information may be decoded in units of slices, and the LC active number information may be decoded together with at least one of L0 active number information and L1 active number information, based on the reference list active number modification flag information.

In addition to the LC default number information decoded in operation 121, LC modification-related information may be decoded in units of slices. According to an aspect of an exemplary embodiment, the LC modification-related information may be extracted together with parameters for a current slice from a received video stream and then be decoded. According to an aspect of an exemplary embodiment, the LC modification-related information may be decoded together with at least one of L0 modification-related information and L1 modification-related information, in units of slices.

A video encoding method and apparatus for performing prediction encoding on prediction units and partitions, based on coding units having a tree structure, and a video decoding method and apparatus for performing prediction decoding on prediction units and partitions, based on coding units having a tree structure, will now be described with reference to FIGS. 13 to 27.

FIG. 13 is a block diagram of a video encoding apparatus 100 capable of predicting video, based on coding units having a tree structure, according to an aspect of an exemplary embodiment.

The video encoding apparatus 100 includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an aspect of an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an aspect of an exemplary embodiment may be characterized by a maximum size and a depth. The depth denotes a number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an aspect of an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units.

The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split to regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an aspect of an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an aspect of an exemplary embodiment is an index related to the number of splitting times from a maximum coding unit to a minimum coding unit. A first maximum depth according to an aspect of an exemplary embodiment may denote the total number of splitting times from the maximum coding unit to the minimum coding unit. A second maximum depth according to an aspect of an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to method of orthogonal transformation or integer transformation.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. A partition is a data unit obtained by splitting a prediction unit of a coding unit, and a prediction unit may be a partition that is equal to a coding unit in terms of size.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit. To perform the transformation on a coding unit, the transformation may be performed based on a transformation unit having a size smaller than or equal to that of the coding unit. For example, a transformation unit may include a transformation unit for an intra mode and a transformation unit for an inter mode.

Similarly to coding units having a tree structure, a transformation unit in a coding unit may be recursively split into smaller sized sub transformation units, so that residual data in the coding unit may be divided according to transformation units having a tree structure, according to transformation depths.

A transformation depth indicating the number of splitting times to reach the transformation unit by splitting the height and width of the coding unit may also be set in a transformation unit. For example, in a current coding unit of 2N×2N, a transformation depth may be ‘0’ when the size of a transformation unit is 2N×2N, may be ‘1’ when the size of a transformation unit is N×N, and may be ‘2’ when the size of a transformation unit is N/2×N/2. That is, transformation units may be set to have a tree structure according to a transformation depth.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

Coding units according to a tree structure in a maximum coding unit, and a method of determining a prediction unit/partition and a transformation unit according to exemplary embodiments will be described in detail with reference to FIGS. 9 to 19 below.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an aspect of an exemplary embodiment is a rectangular data unit obtained by splitting the minimum coding unit constituting the lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of a coding unit defined according to pictures, slices, or GOPs, and information about a maximum depth may be inserted into a header of a bitstream, a sequence parameter set, a picture parameter set or the like.

Also, information about a maximum size and minimum size of a transformation unit for current video may be output via a header of a bitstream, a sequence parameter set, a picture parameter set, or the like. The output unit 130 may encode and output reference information, prediction information, as described above with reference to FIGS. 1 to 6.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum of four coding units of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having high resolution or large data amount is encoded in a related art macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 100 of FIG. 13 is capable of performing prediction encoding as performed by the video prediction encoding apparatus 10 described above with reference to FIGS. 1A and 1B.

The coding unit determiner 120 may perform operations of the prediction encoder 14 included in the video prediction encoding apparatus 10 of FIG. 1. In other words, the coding unit determiner 120 may perform prediction and motion compensation that are operations of the prediction encoder 14, based on prediction units and partitions included in each of coding units having a hierarchical tree structure, which are obtained by splitting a current image. In particular, reference images may be determined using reference lists L0 and L1 and an LC reference list in order to perform bi-prediction on a partition that is a B type slice. According to an aspect of an exemplary embodiment, bi-prediction may be performed on a B type slice by using reference images and a reference order according to one among the reference lists L0 and L1 and the LC reference list.

The coding unit determiner 120 may determine a prediction error of a current partition by prediction encoding the current partition by referring to reference images according to the reference lists L0 and L1 and the LC reference list, in a reference order. In order to perform motion compensation on the prediction error, the coding unit determiner 120 may restore a prediction image by referring to reference images for bi-prediction according to the reference lists L0 and L1 and the LC reference list, in a reference order. Coding units corresponding to a coded depth that are determined as described above may form coding units having a tree structure.

The output unit 130 of the video encoding apparatus 100 may perform an outputting operation of the video prediction encoding apparatus 10. In other words, the output unit 130 may output quantized transformation coefficients of prediction errors produced by performing bi-prediction in units of coding units having a tree structure of each of maximum coding units.

The output unit 130 may encode and output information about coded depths of coding units having a tree structure and information about an encoding mode. The information about the encoding mode may include reference information and prediction mode information determined by performing prediction encoding according to an aspect of an exemplary embodiment. The reference information may include indexes of reference images, motion information indicating a reference block, and the like.

The output unit 130 may encode reference list related information, as prediction mode information regarding bi-prediction performed on a B type slice according to an aspect of an exemplary embodiment.

According to an aspect of an exemplary embodiment, reference list related information for bi-prediction may be encoded in units of slices each including a current partition, in units of sequences, or in units of pictures.

FIG. 14 is a block diagram of a video decoding apparatus 200 capable of predicting video, based on coding units having a tree structure, according to an aspect of an exemplary embodiment.

The video decoding apparatus 200 includes a receiver 210, an image data and encoding information extractor 220, and an image data decoder 230.

Definitions of various terms, such as a coding unit, a depth, a prediction unit, a transformation unit, and information about various encoding modes, for explaining decoding operations of the video decoding apparatus 200 are identical to those described with reference to FIG. 13 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation on each of maximum coding units by decoding information about transformation units having a tree structure of each of coding units and performing inverse transformation on each of the coding units, based on the transformation units. Through the inverse transformation, pixel values of a spatial domain of each of the coding units may be restored.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to the each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. A current coding unit may be decoded by obtaining information about an encoding mode of each of coding units determined as described above.

The video decoding apparatus 200 of FIG. 14 may perform prediction decoding as performed by the video prediction decoding apparatus 200 described above with reference to FIG. 2.

According to an aspect of an exemplary embodiment, the image data and encoding information extractor 220 may extract a quantized transformation coefficient of a prediction error produced by performing prediction in units of coding units having a tree structure, from a parsed bitstream.

Also, the image data and encoding information extractor 220 may extract not only information about a coded depth of coding units having a tree structure and information about an encoding mode but also prediction mode information according to an aspect of an exemplary embodiment, from the parsed bitstream. The image data and encoding information extractor 220 may extract reference information and prediction mode information determined by performing prediction encoding according to an aspect of an exemplary embodiment, from the information about the encoding mode. Indexes of reference images and motion information indicating a reference block may be extracted from the reference information.

The image data and encoding information extractor 220 may extract reference list related information from prediction mode information regarding bi-prediction performed on a B type slice according to an aspect of an exemplary embodiment. For example, L0/L1/LC default number information, L0/L1/LC active number related information, and L0/L1/LC modification related information, which are determined by the LC related information determination unit 12, may be extracted as prediction mode information by the image data and encoding information extractor 220. According to an aspect of an exemplary embodiment, prediction mode information determined by performing bi-prediction may be additionally extracted in units of slices each including a current partition, in units of sequences, or in units of pictures.

The image data decoder 230 of the video decoding apparatus 200 may perform an operation of the prediction decoder 24 included in the video prediction decoding apparatus 20.

The image data decoder 230 may determine coding units having a tree structure, based on information about a coded depth and an encoding mode, and may determine partitions for each of the coding units. The image data decoder 230 may restore a prediction error of each of coding units by performing decoding (including inverse quantization and inverse transformation) on encoded image data in units of coding units having a tree structure of a current image.

The image data decoder 230 may perform prediction decoding on a prediction error, based on partitions included in each of coding units having a tree structure. In particular, partitions of a B type slice on which bi-prediction may be performed may be prediction decoded by using reference images according to reference lists L0 and L1 and an LC reference list. The image data decoder 230 may restore a predicted region of a current partition by referring to the reference images according to the reference lists L0 and L1 and the LC reference list, in a reference order.

Accordingly, the image data decoder 230 may produce a restored image of a current image by performing prediction decoding on each of partitions of coding units having a tree structure, in units of maximum coding units.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded. Also, the maximum size of coding unit is determined considering resolution and an amount of image data.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

A method of determining coding units having a tree structure, a prediction unit, and a transformation unit, according to an aspect of an exemplary embodiment, will now be described with reference to FIGS. 3 through 13.

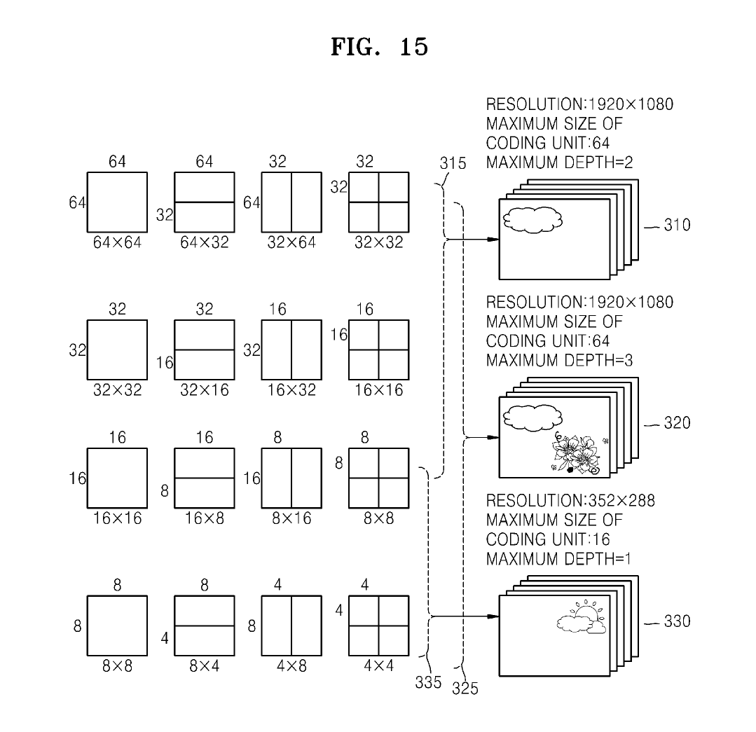

FIG. 15 is a diagram for describing a concept of coding units according to an aspect of an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 9 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

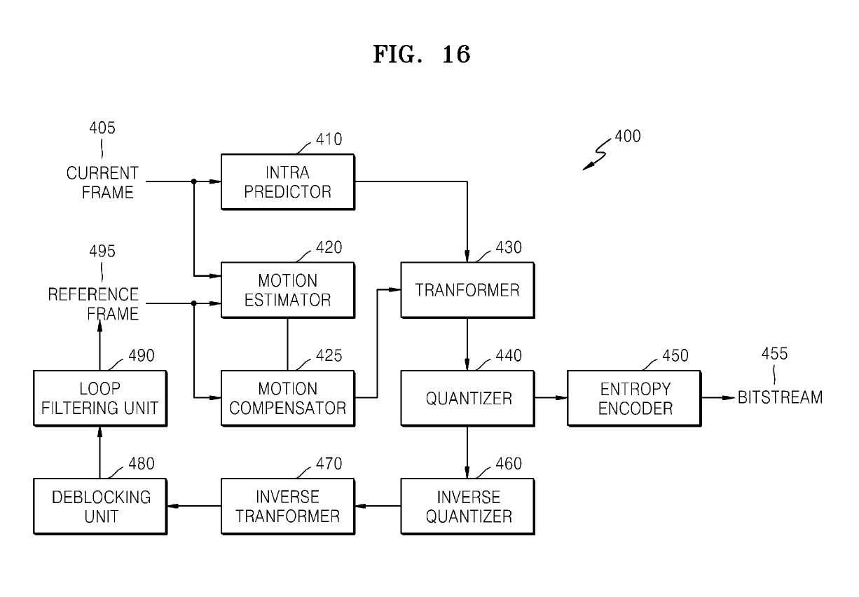

FIG. 16 is a block diagram of an image encoder 400 based on coding units, according to an aspect of an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determines partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

The motion estimator 420 and the motion compensator 425 may determine reference lists L0 and L1 and an LC reference list to determine reference images that are B type slices on which bi-prediction may be performed. The LC reference list may be constructed by using reference images included in the reference lists L0 and L1, based on a default number of active reference images assigned to the LC reference list set for each of pictures. A default number of active reference images assigned to the reference list L0/L1/LC may be arbitrarily changed in units of slices or pictures. Reference images assigned to the reference list L0/L1/LC or a reference order in which the reference images are to be referred may be changed in units of slices or pictures. In this case, the motion estimator 420 may determine a prediction error by predicting a current image by referring to reference images according to the changed reference list L0/L1/LC, in a reference order. Similarly, the motion estimator 420 may produce a restored image of a current image by compensating for a prediction error of the current image by referring to reference images according to the changed reference list L0/L1/LC, in a reference order.

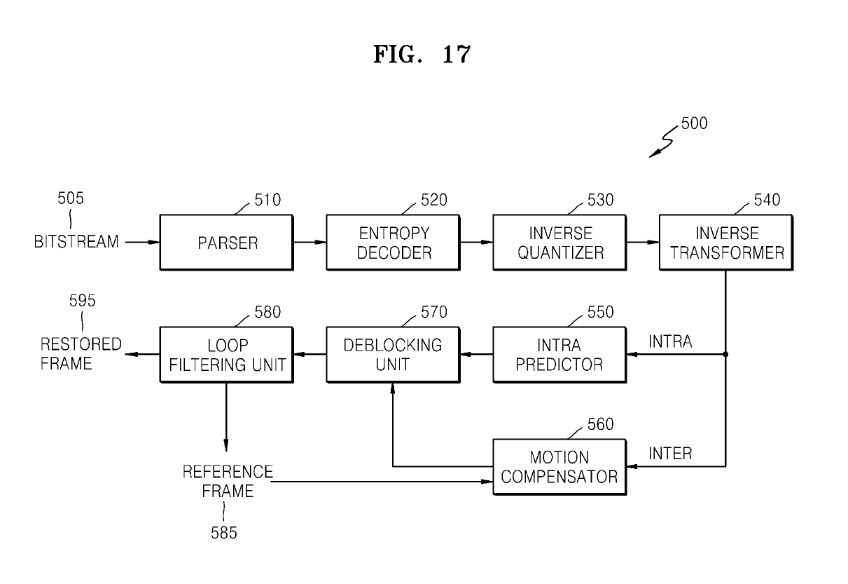

FIG. 17 is a block diagram of an image decoder 500 based on coding units, according to an aspect of an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra prediction 550 and the motion compensator 560 perform operations based on partitions and a prediction mode for each of the coding units having a tree structure, and the inverse transformer 540 perform operations based on a size of a transformation unit for each coding unit.

The motion compensator 560 may determine reference lists L0 and L1 and an LC reference list to determine reference images that are B type slices on which bi-prediction may be performed. The LC reference list may be constructed using reference images included in the reference lists L0 and L1, based on a default number of active reference images assigned to the LC reference list set in units of pictures. Also, a default number of active reference images assigned to the reference list L0/L1/LC may be arbitrarily changed in units of slices or pictures. Reference images assigned to the reference list L0/L1/LC or a reference order in which the reference images are to be referred may be changed in units of slices or pictures. In this case, the motion compensator 560 may produce a restored image of a current image by compensating for a prediction error of the current image by referring to reference images according to the changed reference list L0/L1/LC, in a reference order.

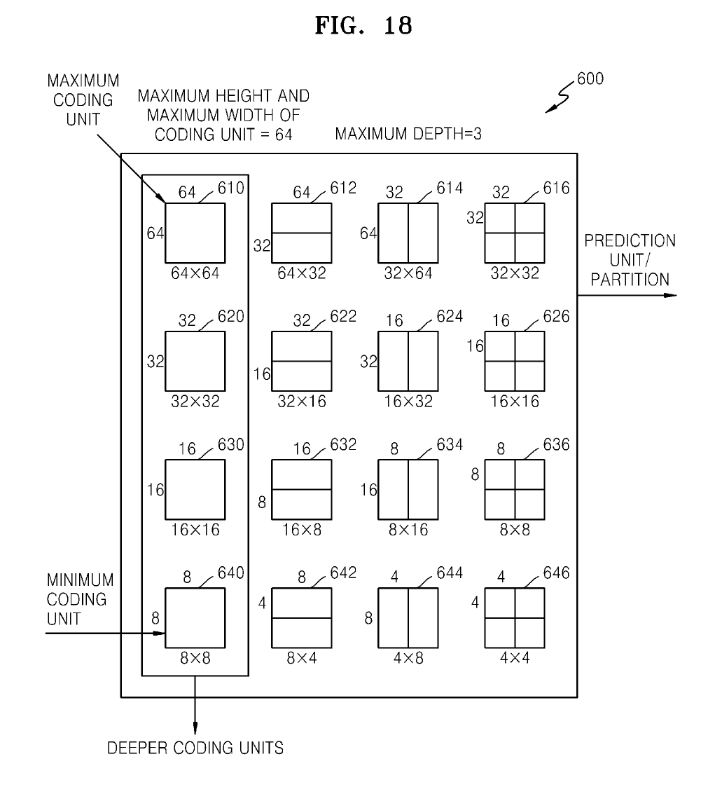

FIG. 18 is a diagram illustrating deeper coding units according to depths, and partitions, according to an aspect of an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an aspect of an exemplary embodiment, the maximum height and the maximum width of the coding units are each 64, and the maximum depth is 4. In this case, the maximum depth denotes a total number of times a maximum coding unit is hierarchically split into minimum coding units. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth deepens or as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens or as the depth increases along the vertical axis of the hierarchical structure 600. A depth and a partition having the minimum encoding error in the coding unit 610 may be selected as the coded depth and a partition type of the coding unit 610.

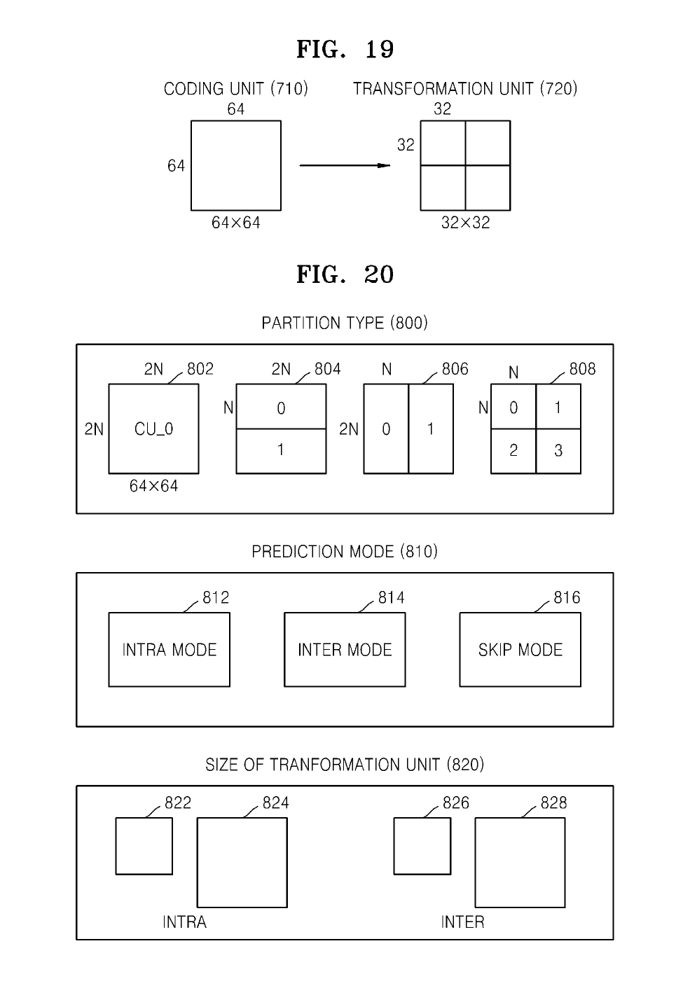

FIG. 19 is a diagram for describing a relationship between a coding unit 710 and transformation units 720, according to an aspect of an exemplary embodiment.

The video encoding apparatus 100 or 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 20 is a diagram for describing encoding information of coding units corresponding to a coded depth, according to an aspect of an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit

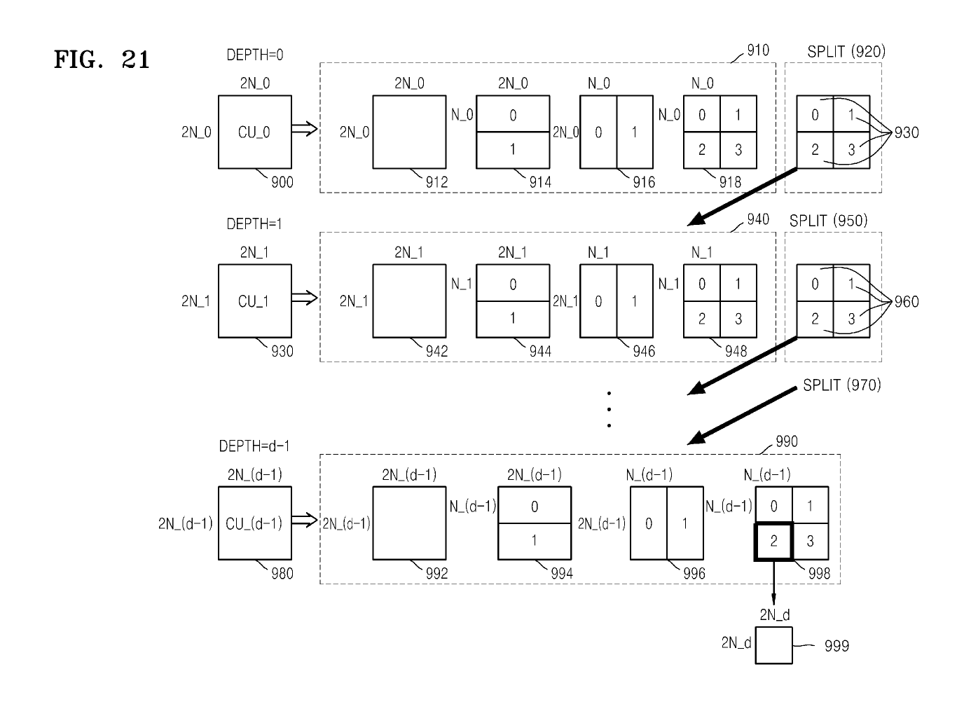

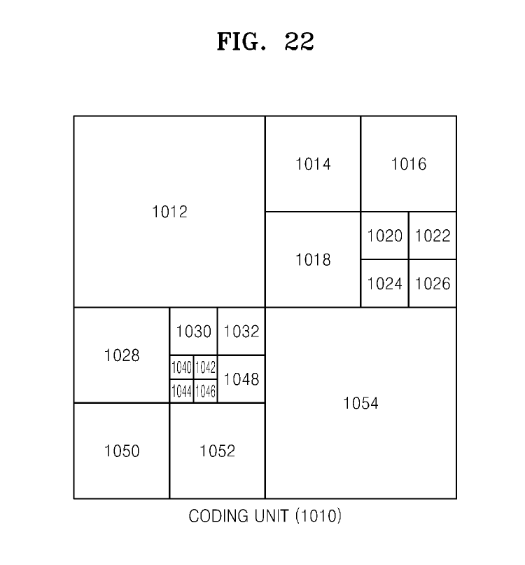

FIG. 21 is a diagram of deeper coding units according to depths, according to an aspect of an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, a coding unit corresponding to each depth may be split until a depth becomes d−1, and split information may be set until a depth is d−2. In other words, when encoding is performed until the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an aspect of an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

FIGS. 22, 23, and 24 are diagrams for describing a relationship between coding units 1010, prediction units 1060, and transformation units 1070, according to an aspect of an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | Split |
|---|---|---|---|---|---|
| (Encoding on Coding Unit Having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

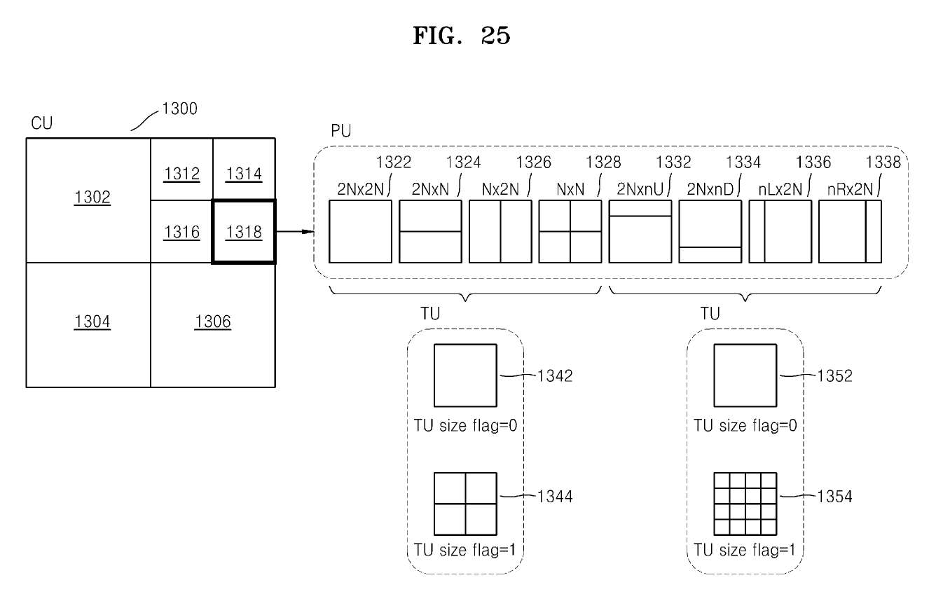

FIG. 25 is a diagram illustrating a relationship between a coding unit, a prediction unit, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Transformation unit split information (TU size flag) is a type of transformation index. The size of a transformation unit corresponding to a transformation index may vary according to a prediction unit type or partition type of a coding unit.

For example, if the partition type is set to be symmetrical, i.e. the partition type 1322, 1324, 1326, or 1328, then a transformation unit 1342 having a size of 2N×2N may be set when the TU size flag is 0, and a transformation unit 1344 having a size of N×N may be set when the TU size flag is 1.

If the partition type is set to be asymmetrical, i.e., the partition type 1332, 1334, 1336, or 1338, then a transformation unit 1352 having a size of 2N×2N may be set when the TU size flag is 0, and a transformation unit 1354 having a size of N/2×N/2 may be set when TU size flag is 1.

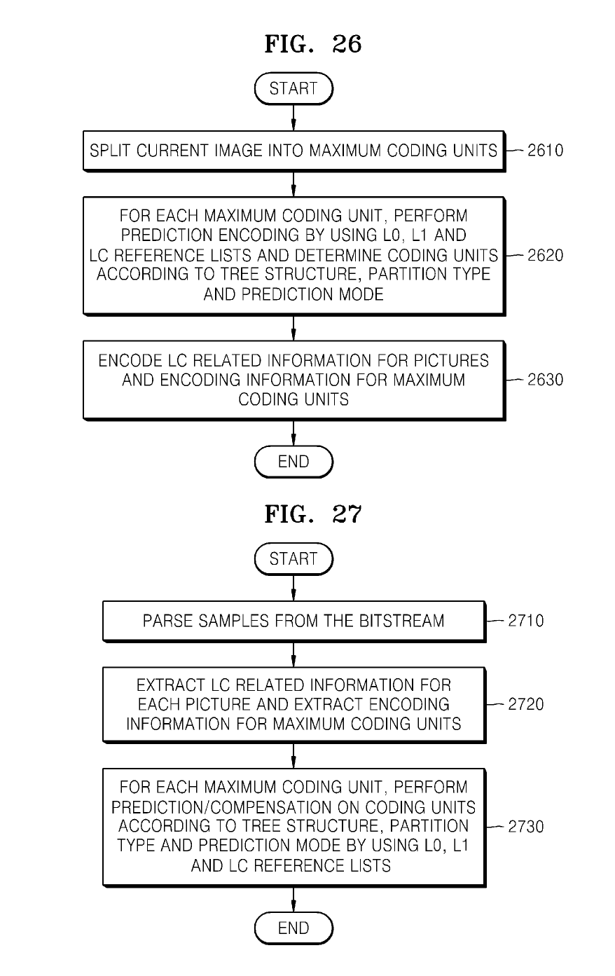

FIG. 26 is a flowchart illustrating a method of encoding a video, based on coding units having a tree structure, according to an aspect of an exemplary embodiment.

In operation 2610, a current image is split into at least one maximum coding unit. A maximum depth indicating the total number of possible splitting times may be predetermined.

In operation 2620, a coded depth to output a final encoding result according to at least one split region, which is obtained by splitting a region of each maximum coding unit according to depths, is determined by encoding the at least one split region, and a coding unit according to a tree structure (or coding units having a tree structure) is determined. The maximum coding unit is spatially split whenever the depth deepens, and thus is split into coding units of a lower depth. Each coding unit may be split into coding units of another lower depth by being spatially split independently from adjacent coding units. Encoding is repeatedly performed on each coding unit according to depths.

Prediction and motion compensation may be performed on prediction units and partitions included in each of hierarchical coding units split from a current image. To perform bi-prediction on a B type slice, reference images may be determined based on reference lists L0 and L1 and an LC reference list.

A prediction error of a current partition may be determined by prediction encoding the current partition by referring to reference images for bi-directional prediction according to the reference list L0/L1/LC, in a reference order. Also, a predicted region of a current partition may be restored by performing motion compensation on a prediction error of the current partition by referring to the reference images according to the reference list L0/L1/LC in a reference order. Coding units corresponding to coded depths determined as described above may be determined as coding units having a tree structure

Also, a transformation unit according to partition types having the least encoding error is determined for each deeper coding unit. In order to determine a coded depth having a minimum encoding error in each maximum coding unit, encoding errors may be measured and compared in all deeper coding units according to depths.

In operation 2630, encoded image data that is the final encoding result according to the coded depth is output together with encoded information about the coded depth and an encoding mode, in units of maximum coding units. The information about the encoding mode may include information about a coded depth or split information, information about a partition type of a prediction unit, information about a prediction mode, and the like.

In other words, a quantized transformation coefficient of a prediction error produced by performing bi-prediction according to an aspect of an exemplary embodiment may be output in units of coding units having a tree structure of each of maximum coding units.

According to an aspect of an exemplary embodiment, information about a coded depth and an encoding mode for coding units having a tree structure may be encoded and output. According to another aspect of an exemplary embodiment, reference information including indexes of reference images determined through bi-prediction and motion information indicating a reference block may be output together with a quantized transformation coefficient of a prediction error and prediction mode information.

According to an aspect of an exemplary embodiment, reference list related information may be encoded and output as prediction mode information regarding bi-prediction performed on a B type slice. For example, L0/L1/LC default number information, L0/L1/LC active number related information, and L0/L1/LC modification related information may be encoded and output as the prediction mode information. According to an aspect of an exemplary embodiment, the reference list related information for bi-prediction may be encoded in units of slices each including a current partition, in units of sequences, or in units of pictures.

The encoded information about the encoding mode may be transmitted to a decoding side, together with the encoded image data.

FIG. 27 is a flowchart illustrating a method of decoding a video, according to an aspect of an exemplary embodiment.

In operation 2710, a bitstream of an encoded video is received and parsed.

In operation 2720, encoded image data of a current picture assigned to a maximum coding unit, and information about a coded depth and an encoding mode according to maximum coding units are extracted from the parsed bitstream. The coded depth of each maximum coding unit is a depth having the least encoding error in each maximum coding unit. In encoding each maximum coding unit, the image data is encoded based on at least one data unit obtained by hierarchically splitting the each maximum coding unit according to depths.

According to the information about the coded depth and the encoding mode, the maximum coding unit may be split into coding units having a tree structure. Each of the coding units having the tree structure is determined as a coding unit corresponding to a coded depth, and is optimally encoded as to output the least encoding error. Accordingly, encoding and decoding efficiency of an image may be improved by decoding each piece of encoded image data in the coding units after determining at least one coded depth according to coding units.

According to an aspect of an exemplary embodiment, reference information and prediction mode information for prediction decoding may be extracted as information about an encoding mode. According to an aspect of an exemplary embodiment, indexes of reference images and motion information may be extracted as reference information for prediction decoding.

According to an aspect of an exemplary embodiment, reference list related information including L0/L1/LC default number information, L0/L1/LC active number related information, and L0/L1/LC modification related information may be extracted as prediction mode information for bi-prediction performed on an image that is a B type slice. According to an aspect of an exemplary embodiment, the L0/L1/LC active number related information and the L0/L1/LC modification related information may be decoded in units of slices, pictures, or sequences.

In operation 2730, the image data of each maximum coding unit is decoded based on the information about the coded depth and the encoding mode for each of the maximum coding units. While a current coding unit is decoded based on the information about the coded depth and the encoding mode, prediction units or partitions are determined based on partition type information and a prediction mode of each of the partitions is determined based on prediction mode information, thereby prediction encoding each of the partitions.

A reference list including reference images and a reference order may be determined to perform motion compensation on partitions that are B type slices on which bi-prediction may be performed. A restored region of a current image may be produced by performing motion compensation on a prediction error of each of the partitions by referring to reference images according to reference lists L0 and L1 and an LC reference list in a reference order.

Exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

While the inventive concept has been particularly shown and described with reference to exemplary embodiments thereof, it will be understood by those of ordinary skill in the art that various changes in form and details may be made therein without departing from the spirit and scope of the exemplary embodiments as defined by the appended claims. The exemplary embodiments should be considered in descriptive sense only and not for purposes of limitation. Therefore, the scope of the invention is defined not by the detailed description but by the appended claims, and all differences within the scope will be construed as being included in the present invention.

What is claimed is:

1. A method of prediction encoding video, the method comprising:
setting list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice;
determining the LC reference list to include at least one reference image from among the plurality of reference images included in the reference lists L0 and L1, based on the LC default number information; and
prediction encoding the current image that is a B type slice by using the determined LC reference list.

2. The method of claim 1, wherein the setting of the LC default number information in units of pictures comprises setting LC active number modification flag information and LC active number information in units of slices, based on reference list active number modification flag information indicating whether a number of active reference images assigned to a reference list is arbitrarily changed, and
wherein the LC active number modification flag information indicates whether a number of active reference images assigned to the LC reference list is arbitrarily changed, and the LC active number information indicates a current number of active reference images assigned to the LC reference list after the number of active reference images assigned to the LC reference list is arbitrarily changed.

3. The method of claim 1, wherein the setting of the LC default number information in units of pictures comprises setting LC modification-related information including reference images assigned to the LC reference list or information about a method of changing a reference order, in units of slices.

4. The method of claim 1, wherein transmission of LC flag information indicating whether the LC reference list is to be constructed using at least one reference image from among the plurality of reference images included in the reference list L0 and the reference list L1 is not determined and encoded.

5. The method of claim 1, wherein the setting of the LC default number information in units of pictures comprises setting the LC default number information together with at least one of L0 default number information and L1 default number information, in units of pictures, and
wherein the L0 default number information indicates a default number of active reference images assigned to the reference list L0 and the L1 default number information indicates a default number of active reference images assigned to the reference list L1.

6. The method of claim 2, wherein the setting of the LC active number information in units of slices comprises setting the LC active number information together with at least one of L0 active number information and L1 active number information, in units of slices, based on the reference list active number modification flag information, and
wherein the L0 active number information indicates a current number of active reference images assigned to the reference list L0 after the number of active reference images assigned to the L0 reference list is arbitrarily changed, and the L1 active number information indicates a current number of active reference images assigned to the reference list L0 after the number of active reference images assigned to the L1 reference list is arbitrarily changed.

7. The method of claim 3, wherein the setting of the LC modification-related information in units of slices comprises setting the LC modification-related information together with at least one of L0 modification-related information and L1 modification-related information, in units of slices, and
wherein the L0 modification-related information includes reference images assigned to the reference list L0 or a method of changing a reference order, and the L1 modification-related information includes reference images assigned to the reference list L0 or a method of changing a reference order.

8. The method of claim 1, further comprising transmitting the LC default number information together with parameters for a current picture.

9. The method of claim 2, further comprising transmitting the LC active number information together with parameters for a current slice.

10. The method of claim 3, further comprising transmitting the LC modification related information together with parameters for a current slice.

11. A method of prediction decoding video, the method comprising:
decoding list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice;
determining the LC reference list to include at least one reference image from among the plurality of reference images included in the reference lists L0 and L1, based on the LC default number information; and
prediction decoding the current image that is a B type slice by using the determined LC reference list.

12. The method of claim 11, wherein the decoding of the LC default number information in units of pictures comprises:
decoding LC active number modification flag information in units of slices, based on reference list active number modification flag information indicating whether a number of active reference images assigned to a reference list is arbitrarily changed, the LC active number modification flag information indicating whether a number of active reference images assigned to the LC reference list is arbitrarily changed; and
decoding LC active number information indicating a current active number of reference images assigned to the LC reference list after the number of active reference images assigned to the LC reference list is arbitrarily changed, based on the decoded LC active number modification flag information.

13. The method of claim 11, wherein the decoding of the LC default number information in units of pictures comprises decoding LC modification-related reference information including reference images assigned to the LC reference list or information about a method of changing a reference order, in units of slices.

14. The method of claim 11, wherein the determining of the LC reference list comprises determining the LC reference list without having to decode LC flag information indicating whether the LC reference list is to be constructed using at least one reference image from among the plurality of reference images included in the reference list L0 and the reference list L1.

15. The method of claim 11, wherein the decoding of LC default number information in units of pictures comprises, decoding the LC default number information together with at least one of L0 default number information and L1 default number information, in units of pictures, and
wherein the L0 default number information indicates a default number of active reference images assigned to the reference list L0, and the L1 default number information indicates a default number of active reference images assigned to the reference list L1.

16. The method of claim 11, wherein the reading of the LC default number information in units of pictures comprises:
decoding reference list active number modification flag information indicating whether a number of active reference images assigned to a reference list is arbitrarily changed, in units of slices; and
decoding LC active number information together with at least one of L0 active number information and L1 active number information, based on the decoded reference list active number modification flag information, and
wherein the L0 active number information indicates a current number of active reference images assigned to the reference list L0 after the number of active reference images assigned to the L0 reference list is arbitrarily changed, and the L1 active number information indicates a current number of active reference images assigned to the reference list L0 after the number of active reference images assigned to the L1 reference list is arbitrarily changed.

17. The method of claim 13, wherein the decoding of the LC modification-related information in units of slices comprises decoding the LC modification-related information together with at least one of L0 modification-related information and L1 modification-related information, in units of slices, and
wherein the L0 modification-related information indicates reference images assigned to the reference list L0 or a method of changing a reference order and the L1 modification-related information indicates reference images assigned to the reference list L1 or a method of changing a reference order.

18. The method of claim 11, wherein the decoding of the LC default number information in units of pictures comprises:
extracting the LC default number information together with parameters for a current picture, from a received video stream; and
decoding the extracted LC default number information.

19. The method of claim 12, wherein the decoding of the LC active number information in units of slices comprises:
extracting the LC active number information together with parameters for a current slice, from a received video stream; and
decoding the extracted LC active number information.

20. The method of claim 13, wherein the decoding of the LC active modification related information in units of slices comprises:
extracting the LC active modification related information together with parameters for a current slice, from a received video stream; and
decoding the extracted LC active modification related information.

21. An apparatus for prediction encoding video, the apparatus comprising:
a list combination (LC) related information determination unit for setting LC default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; and
a prediction encoder for determining the LC reference list to include at least one reference image from among the plurality of reference images included in the reference lists L0 and L1, based on the LC default number information, and prediction encoding the current image that is a B type slice by using the determined LC reference list.

22. An apparatus for prediction decoding video, the apparatus comprising:
an LC-related information decoder for decoding list combination (LC) default number information indicating a default number of active reference images assigned to an LC reference list, in units of pictures, the LC reference list including at least one reference image from among a plurality of reference images included in reference lists L0 and L1 which are information about lists of reference images for prediction encoding a current image that is a B type slice; and
a prediction decoder for determining the LC reference list to include at least one reference image from among the plurality of reference images included in the reference lists L0 and L1, based on the LC default number information, and prediction decoding the current image that is a B type slice by using the determined LC reference list.

23. A non-transitory computer readable recording medium having recorded thereon a computer program for performing the method of claim 1.

24. A non-transitory computer readable recording medium having recorded thereon a computer program for performing the method of claim 11.
